(19) United States
(12) Patent Application Publication
(10) Pub. No.: US 2010/0060723 A1
(43) Pub. Date: Mar. 11, 2010

(54) DISPLAY SYSTEM

(75) Inventors: Kazunori Kimura, Minato-Ku (JP); Masao Imai, Minato-Ku (JP); Daigo Miyasaka, Minato-Ku (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, MINATO-KU, TOKYO (JP)

(21) Appl. No.: 12/513,287

(22) PCT Filed: Nov. 7, 2007
(86) PCT No.: PCT/JP2007/071743

§ 371 Date: May 1, 2009

(30) Foreign Application Priority Data
Nov. 8, 2006 (JP) 2006-303399

(51) Int. Cl. H04N 13/04; G09G 5/10; G02F 1/1335

(52) U.S. Cl. 348/56; 345/691; 349/15; 348/E13.075

(57) ABSTRACT

[Problems] To eliminate flicker when a normal image is presented to user employing an optical shutter from two types or more of image under intermittent illumination of such as fluorescent lamp.

[Means for Solving Problems] In a display system (10) including a display panel (11A) which can display two types or more of image sequentially and repeatedly, and an optical shutter (13) which opens with the display cycle of a specific image among the images displayed on the screen of the display panel (11A), display cycle of the specific image on the display panel (11A) is set equal to an integer multiple of the flashing cycle of intermittent illumination (15) under intermittent illumination (15) flashing periodically.

### TECHNICAL FIELD

The present invention relates to a display system, and particularly, to a display system which presents a stereoscopic vision or which prevents secret information from being viewed by a person other than a specified user, a specific image display method executed by the display system, and an operation control program.

### BACKGROUND ART

Today, a laptop computer, a personal digital assistance (PDA), and a mobile phone have been used daily in conveyances such as a train and an airplane, or various public facilities, at which other people present. This trend is expected to be accelerated more in the future according to an increase of the public LAN facilities due to the progress in the ubiquitous information society. Under such an environment, there rise such security and privacy issues that a displayed content on a display is viewed from surrounding people.

Meanwhile, a trend of protecting secret information is growing as indicated by an enactment of Private information Protection Law, and some measures such as protecting highly confidential information from being viewed by people other than a qualified viewer are required when using a desktop machine in an office as well as when using a lap top at outside, as described above.

As a technique responding to such a requirement, for example, a display system with which only a specified user can view an intended image is proposed, by combining a display of a plurality of images and an optical shutter synchronized therewith (Patent Document 1).

The content of Patent Document 1 will be described according to FIG. 25. In this example, a normal image 71 that is an image intended to be displayed originally, and an inverted image 72 that is formed by inverting the normal image 71, are displayed on the display panel 74 repeatedly by being switched at approximately equal time interval by a display control part 77. And at the same time, an optical shutter 75 existing before the viewer's eyes is synchronized with the normal image 71 to be in a transparent state, as shown in sequence 73.

With this, an image displayed on the display panel 74 is recognized for the user of the optical shutter 75 as a display image 76 that is the normal image 71, and for surrounding unspecified people, a whole screen is recognized as a halftone, gray image, where the normal image 71 and the inverted image 72 are overlapped. Although not described in Patent Document 1, by adding a public image to the normal image and the inverted image, it is also possible to transmit the secret information to a specified person by the normal image while having unspecified person to recognize the public image.

This technique is applicable not only to the protection of the secret information, but also to a multi channel display which displays a plurality of images repeatedly on a same display panel and enables a plurality of viewers to select and view one of the plurality of images, by having the plurality of viewers to use the optical shutters whose transmission timing are shifted from each other, and also to a stereoscopic display which realizes a stereoscopic vision by using the optical shutters whose opening/closing timings for right eye and left eye are shifted.

By the way, at the method of using the display of the plurality of images and the optical shutter synchronized therewith, light of a fluorescent lamp also passes through the optical shutter, together with the video image from the display panel, when it is in a room. The fluorescent lamp not using an inverter flashes at twice the frequency of the commercial power frequency, and if there is a difference between a cycle of the flash and a cycle from a transmittance state to a next transmittance state of the optical shutter, a flicker is sometimes caused to the light transmitted through the optical shutter.

In Japan, the commercial power frequency is 50 Hz at Kanto area, and 60 Hz at Kansai area. In Europe, the frequency is 50 Hz, and in USA, it is 60 Hz. In the ubiquitous information society, there will be many occasions as carrying a laptop computer to use in a lot of areas and countries, and in such cases, the flickers arising from the commercial power frequency described above becomes a problem in particular.

Further, as a light source for a lighting device, the LED and the organic EL which are free from mercury are expected to be used in the future, not limited to the fluorescent lamp traditionally used. In such a case, they flash at a frequency different from the commercial power frequency sometimes, therefore the flicker is considered to be generated in a different manner.

When the flicker is generated, it causes user not only discomfort feeling but also eyestrain, and further causes healthy problems, such as interfering the bodily function. As a measure against those problems, a method with which illuminating light is prevented from incoming from the surroundings by arranging light shielding plates around the optical shutter is proposed in a stereoscopic image display system (Patent Document 2).

As another case, a stereoscopic image display system which sets the opening/closing period of the optical shutter as 1/60 second initially, and when it is used in the area where the commercial power frequency is 50 Hz, the occurrence of the flicker is prevented by including all of the effective video periods and blanking periods before and after the effective video periods within opening periods of either one of the left and right shutters to bring the opening period to close to 1/100 second which is the flashing period of the fluorescent lamp, is disclosed (Patent Document 3).

Further, although the technique belong to a field of an imaging device such as a video camera, a method with which, by detecting a luminance of the fluorescent lamp, the shutter speed is changed according to the luminance, to be higher when it is dark and lower when it is bright has been known, and also, a method with which the timing to open the shutter is changed has been known, as publicly known examples (Patent Document 4).

Patent Document 1: Japanese Unexamined Patent Publication 6-110403

Patent Document 2: Japanese Unexamined Patent Publication 8-205204

Patent Document 3: Japanese Patent Number 003066298

Patent Document 4: Japanese Unexamined Patent Publication 2000-032352

### DISCLOSURE OF THE INVENTION

### Problems to be Solved by the Invention

The effect of the illumination comes around the display surface even if the technique of arranging light shielding plates around the optical shutter shown in Patent Document 2 is applied to the Patent Document 1, and there is such a problem that the effect of the fluorescent lamp cannot be eliminated completely.

Also, in a case when a plurality of images are displayed repeatedly for the purpose of protecting secret information or the like, the period of opening the optical shutter cannot be taken as long as 1/100 second or 1/120 second as described in Patent Document 3, different from the case of the stereoscopic image display. It is the same for a double-frame rate display for displaying a specific image and an inverted image, let alone a triple-frame rate display described later. The reason is that, with a sequential scanning method employed by such as a CRT and a liquid crystal display, if the opening period of the optical shutter is taken longer, the image is recognized as a mixture of the specific image and the inverted image, or, a mixture of the public image and the specific image, for a user of the optical shutter too.

Also, different from a case of a shooting with a video camera disclosed in Patent Document 4, opening period of the optical shutter is limited to the time for displaying the specific image, and further, limited to the time after the writing of the specific image and before the writing of the inverted image. Therefore, the period and timing for opening the shutter cannot be significantly changed enough to uniformize the brightness of the fluorescent lamp.

An exemplary object of the invention is to provide a display system that can effectively eliminate the flicker generated due to the difference between a flashing cycle of the intermittent illumination and an opening/closing cycle of the optical shutter when viewing a specific image only by using an optical shutter which opens and closes in synchronization with the specific image among two or more types of images displayed repeatedly under the intermittent illumination such as the fluorescent lamp.

### Means for Solving the Problems

In order to achieve the foregoing exemplary object, a display system according to an exemplary aspect of the invention is a system that displays two or more types of images including a specific image sequentially and repeatedly by a display device under an intermittent illumination, includes a control device which controls a display cycle of the specific image and a flashing cycle of the intermittent illumination in such a manner that the display cycle of the specific image is set equal to an integer multiple of the flashing cycle of the intermittent illumination under the intermittent illumination which flashes periodically.

Here, the invention is configured as hardware. However, the invention is not limited to hardware, and it may be configured as a specific image display method, an operation control program as software, and a control system.

When this invention is configured as a specific image display method, the specific image display method according to another exemplary aspect of the invention is configured to control a display cycle of the specific image included in two or more types of images displayed sequentially and repeatedly and a flashing cycle of an intermittent illumination in such a manner that the display cycle of the specific image is set equal to an integer multiple of the flashing cycle of the intermittent illumination under the intermittent illumination which flashes periodically.

When this invention is configured as an operation control program, the operation control program according to still another exemplary aspect of the invention is a program for opening/closing control of the optical shutter in synchronization with a display of a specific image included in two or more types of images, configured to cause a computer to execute a function of controlling a display cycle of the specific image included in two or more types of images displayed sequentially and repeatedly and a flashing cycle of an intermittent illumination in such a manner that the display cycle of the specific image is set equal to an integer multiple of the flashing cycle of the intermittent illumination under the intermittent illumination which flashes periodically.

A control system according to still another exemplary aspect of the invention is a system that controls sequential and repeated displays of two or more types of images including a specific image performed by a display device under an intermittent illumination, is configured to include a control device which controls a display cycle of the specific image and a flashing cycle of the intermittent illumination in such a manner that the display cycle of the specific image is set equal to an integer multiple of the flashing cycle of the intermittent illumination under the intermittent illumination which flashes periodically.

### EFFECTS OF THE INVENTION

With the present invention, when a plurality of images are displayed sequentially and repeatedly under the intermittent illumination such as the fluorescent lamp, it becomes possible to make the light amount of the intermittent illumination transmitting the optical shutter to be constant for each time period when the optical shutter opens, by changing the display cycle of the plurality of images in order to change the opening/closing cycle of the optical shutter which opens/closes in synchronization with the display cycle of the plurality of images, so that opening/closing cycle of the optical shutter is set equal to an integer multiple of the flashing cycle of the intermittent illumination. Accordingly, it becomes possible to provide a display system which can prevent a flicker from being generated due to the difference between the flashing cycle of the intermittent illumination and the opening/closing cycle of the optical shutter and make the display more visible by opening/closing the optical shutter at an optimal opening/closing phase suited to the display style of the display panel.

### BEST MODE FOR CARRYING OUT THE INVENTION

Next, exemplary embodiments of the invention will be described hereinafter by referring to the accompanying drawings.

### First Exemplary Embodiment

FIG. 1 is a block diagram showing a configuration of a display system according to a first exemplary embodiment of the invention. FIG. 2 is a schematic explanatory diagram showing a state of using the display system according to the first exemplary embodiment of the invention.

The display system 10 according to the first exemplary embodiment displays two or more types of images including a specific image sequentially and repeatedly by a display device under an intermittent illumination, and the display system 10 includes a control device 10A, an optical shutter 13, and an intermittent illumination 15.

The control device 10A controls the sequential and repeated display of two or more types of images including the specific image displayed sequentially and repeatedly by the display device (11A) under the intermittent illumination 15, and the control device 10A includes a display control device 11 which controls the display, a display panel 11A, and a flashing cycle detecting device 19 which detects a cycle of the flash generated by the intermittent illumination 15. Further, the display control device 11 includes a main control device 12 which controls the entire display system 10, and a display cycle control device 17 which controls the display cycle of the image displayed on the display panel 11A. In an exemplary embodiment shown in FIG. 1, the display panel 11A is used as the display device. Here, the exemplary embodiment is described with a case in which the display panel 11A is incorporated in the control device 10A. However, the invention is not limited to this, and display panel 11A may be provided independently, separated from the control device 10A.

The optical shutter 13 repeats opening/closing operations in synchronization with the specific image among the images displayed sequentially, and the optical shutter 13 includes a shutter opening/closing device 13A which drives the optical shutter 13, and a shutter opening/closing control device 18 which controls the opening/closing timing of the optical shutter 13.

The display system 10 is assumed to be used under the intermittent illumination 15 such as the fluorescent lamp that repeats flashes periodically. The flashing cycle detecting device 19 can obtain the flashing cycle of the intermittent illumination by detecting the commercial power frequency, etc. For example, the flashing cycle detecting device 19 has only to judge which the flashing cycle of the fluorescent lamp is, 1/100 second or 1/120 second, from the detection result of the commercial power frequency. When the commercial power frequency is already known, a user may obtain the flashing cycle by inputting the value of the commercial power frequency, or by selecting and designating the area. The flashing cycle detecting device 19 may be arranged within the display control device 11. The display control device 11, i.e. the main control device 12, and the display cycle control device 17 operate to set the display cycle of the specific image displayed on the display panel 11A to be equal to an integer multiple of the flashing cycle of the intermittent illumination 15 based on the flashing cycle obtained by the flashing cycle detecting device 19.

A synchronous signal 14 that becomes a reference for controlling the opening/closing timing of the optical shutter 13 is transmitted from the display control device 11 to the shutter opening/closing device 13A, via the shutter opening/closing control device 18. Since the shutter opening/closing control device 18 actions such that the optical shutter 13 repeats the opening/closing operations in synchronization with the display of the specific image, the opening/closing cycle of the optical shutter 13 is set equal to an integer multiple of the flashing cycle of the intermittent illumination 15.

In this case, the optical shutter 13 is made to be lighter and thinner to be able to operate silently by using a liquid crystal type optical shutter. However, the invention is not limited to this, and mechanical type optical shutter or the like can be acceptable. In FIG. 2, a configuration which has a shape of eyeglasses or the like to be used by worn on the ears is shown as an example, but a configuration which has a shape of a card, a hand glass, or the like to be used by held with a hand, and a self-standing configuration such as a partition and a window to be used by being viewed therethrough, may be acceptable. The optical shutter 13 and the shutter opening/closing device 13A may be formed in a unified manner.

The synchronous signal 14 may be transmitted from the shutter opening/closing control device 18 by a wired system, and also, may be transmitted by a wireless system using infrared or radio wave. Further, the shutter opening/closing control device 18 may be provided inside the display control device 11.

FIG. 3 is a flowchart showing a processing routine of the first exemplary embodiment. An operation of the first exemplary embodiment will be described according to the flowchart, FIG. 1, and FIG. 2.

A case in which a normal image display mode is switched to a sequential display mode for a plurality of images is considered (step S101). Switching of the display is performed by, for example, an operation setting device, not shown, connected to the main control device 12. With this, the display control device 11 displays the plurality of images including the specific image on the display panel 11A repeatedly and sequentially (step S102: image display step). The flashing cycle detecting device 19 detects a flashing cycle of the intermittent illumination 15 (step S103: flashing cycle detection step).

Next, the main control device 12 judges whether the current display cycle of the specific image is set equal to an integer multiple of the flashing cycle of the intermittent illumination 15 (step S104). When the display cycle of the specific image is not set equal to an integer multiple of the flashing cycle, the display cycle control device 17 changes the image display cycle of the display panel 11A (step S105: image display cycle adjusting step). In step S104, when the display cycle of the specific image is equal to an integer multiple of the flashing cycle, the shutter opening/closing control device transmits accordingly the synchronous signal 14 which becomes a reference to control the opening/closing timing of the optical shutter 13, and the shutter opening/closing device 13A opens the optical shutter 13 periodically in synchronization with the specific images (step S106: optical shutter opening/closing control step).

With this processing routine, the image display cycle is changed such that the display cycle of the specific image is set equal to an integer multiple of the flashing cycle of the intermittent illumination 15, and the first exemplary embodiment is optimized. When the display cycle of the specific image, i.e., the opening/closing cycle of the optical shutter is set equal to an integer multiple of the flashing cycle of the intermittent illumination, the light amount of the intermittent illumination transmitted through the optical shutter becomes constant within an opening period of the optical shutter, and the flicker is not generated.

Hereinafter, explanation will be made by referring to a specific example.

FIG. 4 is a timing chart showing an example of a waveform and a timing of each portion of the first exemplary embodiment. FIG. 4 shows; a waveform of an AC power source voltage for lighting the intermittent illumination 15 (fluorescent lamp) (1); a waveform showing a change in brightness of the fluorescent lamp (2); a normal display timing by the display panel 11A according to the first exemplary embodiment (3); a display timing in a plural images (three images) display mode according to the first exemplary embodiment (4); the opening/closing timing of the optical shutter 13 which opens/closes in synchronization with the specific images in the plural images display mode (5); and the light amount of the fluorescent lamp transmitting in a time when the optical shutter 13 opens (6). Note that, in (6), the waveform of the graph shows the change in brightness of the light of the fluorescent lamp transmitted through the optical shutter 13, and an area of a filled region shows the light amount.

Here, a cycle of the AC power source voltage waveform (1) is 1/60 second, and a cycle of a brightness change of the fluorescent lamp (2) driven by the AC power source is 1/120 second. At the normal display timing of the first exemplary embodiment (3), the display is switched in 1/60 second. Also, as the display timing in the plural images display mode (4), a timing in such a case that the specific image, the inverted image of the specific image, and the public image are displayed sequentially in this order, during 1/60 second, is shown.

The optical shutter 13 is in opening state from after a writing of the specific image to the display panel 11A is completed till before a writing of the inverted image.

Therefore, on the display panel 11A, the specific image is recognized visually by the user of the optical shutter 13, and the public image is recognized visually by the others.

In this case, a period from a certain specific image to a next specific image is 1/60 second, and it is twice the flashing cycle of the fluorescent lamp (2), which is 1/120 second. That is, in step S104 of FIG. 3, the display cycle of the specific image is set equal to an integer multiple of the flashing cycle of the illumination, proceeding doesn't proceed to step S105 but proceeds to step S106, and the operation of the optical shutter 13 is executed. As the timings are set as described, the transmitted light amount of the fluorescent lamp which transmits the optical shutter 13 is constant at any period in which the shutter opens as shown in (6), and the user of the optical shutter 13 does not perceive the flicker.

Here, when the optical shutter 13 is a liquid crystal type, there is a delay in time from the voltage application to the response of the liquid crystal, so the timing of the liquid crystal driving voltage waveform is not necessarily synchronized completely with the opening/closing timing of the optical shutter 13 (5). The opening/closing timing of the shutter opening/closing device 13A is controlled in view of above-described facts.

Also, when the display panel 11A is a liquid crystal display, a backlight is lit up after the completion of the image writing in a case of the display timing (4). However, the invention is not limited to this, and the optical shutter 13 may be opened at the completion of the writing, with the backlight being lit constantly, or, the backlight may be lit up after the optical shutter 13 opens.

FIG. 5 shows another example of the timing according to the first exemplary embodiment.

In this case, as the plural images to be displayed sequentially, a right eye image and a left eye image for a stereoscopic image mode are used. When the right eye image is displayed, an optical shutter on the right eye side opens, and when the left eye image is displayed, an optical shutter on the left eye side opens.

As shown in FIG. 4, FIG. 5 shows; a waveform of an AC power source voltage for lighting the fluorescent lamp (1); a waveform showing a change in brightness of the fluorescent lamp (2); a normal display timing by the display panel of the first exemplary embodiment (3). Further; a display timing of the left and right eye images in a stereoscopic image mode (4); an opening/closing timing of a right shutter in the stereoscopic image mode (5); the light amount of the fluorescent lamp transmitting the right shutter (6); an opening/closing timing of a left shutter in the stereoscopic image mode (7); and the light amount of the fluorescent lamp transmitting the left shutter (8), in this order.

Also in this case, a period from a certain right or left eye image to a next right or left eye image (4) is 1/60 second, and it is twice the flashing cycle of the fluorescent lamp (2), which is 1/120 second. Accordingly, proceeding proceeds from step S104 to step S106 directly, and the operation of the optical shutter 13 is executed. As the timings are set as described, a value of integral of the light amount transmitted through the right shutter in (6) becomes constant at each period in which the right shutter opens and the light amount transmitted through the left shutter in (7) becomes constant at each period in which the left shutter opens, and the user of the optical shutter 13 does not perceive the flicker.

FIG. 6 is a timing chart for showing a problem to be occurred when the exemplary embodiment of the invention is not applied in such a case that, at the specific image display in the plural images sequential display mode shown in FIG. 4, the frequency of the power source voltage is changed from 1/60 second to 1/50 second and the flashing cycle of the fluorescent lamp is changed from 1/120 second to 1/100 second.

In FIG. 6; a waveform of an AC power source voltage for lighting the fluorescent lamp (1); a waveform showing a brightness change of the fluorescent lamp (2); a normal display timing (3); a display timing in a plural images (three images) display mode (4); the opening/closing timing of the optical shutter 13 in synchronization with the specific images in the plural images display mode (5); and the light amount of the fluorescent lamp transmitting in a time when the optical shutter 13 opens (6) are shown in this order.

In this case, while the flashing cycle of the fluorescent lamp is 1/100 second, the images display cycle remains 1/60 second. Therefore, the light amount transmitting the optical shutter 13 (6) becomes the same amount every 1/20 second which is a common multiple of 1/100 second and 1/60 second, but during that span, the light amount transmitting the shutter varies every opening time of the shutter, and as the result, the brightness fluctuates on a 1/20 second cycle, thus the flicker of 20 Hz is perceived by the user of the optical shutter 13.

Similarly, FIG. 7 is a timing chart for showing a problem to be occurred when the exemplary embodiment of the invention is not applied in such a case that the cycle of the power source voltage is changed to 1/50 second and the flashing cycle of the fluorescent lamp is changed to 1/100 second from the display state in a stereoscopic image mode shown in FIG. 5, when the plural images to be displayed sequentially are the right eye image and left eye image for the stereoscopic image.

In FIG. 7; a waveform showing a change in brightness of the fluorescent lamp (1); a display timing of the left and right eye images in the stereoscopic image mode (2); the opening/closing timing of the right shutter in the stereoscopic image mode (3); the light amount of the fluorescent lamp transmitting through the right shutter (4); the opening/closing timing of the left shutter in the stereoscopic image mode (5); and the light amount of the fluorescent lamp transmitting through the left shutter (6) are shown in this order.

Similar to the case shown in FIG. 6, the light amount transmitting each of the left and right shutters changes on a 1/20 second cycle, thus the flicker of 20 Hz is perceived by the user of the optical shutter 13.

FIG. 8 is a timing chart for showing a case when the exemplary embodiment of the invention is applied to a situation in which the frequency of the power source voltage is changed from 1/60 second to 1/50 second as shown in FIG. 6, and the display cycle of the specific image is changed to be twice the flashing cycle of the intermittent illumination 15.

In FIG. 8; a waveform showing a change in brightness of the fluorescent lamp (1); a display timing in a plural images (three images) display mode (2); the opening/closing timing of the optical shutter 13 in synchronization with the specific images in the plural images display mode (3); and the light amount of the fluorescent lamp transmitting in a time when the optical shutter 13 opens (4) are shown in this order.

In FIG. 8, when the frequency of the power source voltage is changed and the cycle is changed from 1/60 second to 1/50 second, and the flashing cycle of the fluorescent lamp is changed from 1/120 second to 1/100 second, if the display cycle of the specific image remains at 1/60 second, it is not an integer multiple of the flashing cycle of the illumination, 1/100 second, therefore proceeding proceeds to step S105, and the display cycle of the specific image is changed from 1/60 second to 1/50 second by the display cycle control device 17.

With this, in FIG. 8, a display cycle from a certain display point of the specific image to a next display point of the specific image (2) is changed from 1/60 second shown in FIG. 6 to 1/50 second, and it is twice the flashing cycle of the fluorescent lamp, which is 1/100 second. As the result, different from the case shown in FIG. 6, the transmitted light amount of the fluorescent lamp which transmits the optical shutter 13 as shown in (4) is constant at any period in which the shutter opens, and the flicker is not generated.

FIG. 9 shows another example of the case when the exemplary embodiment of the invention is applied to a situation shown in FIG. 6.

In FIG. 9; a waveform showing a change in brightness of the fluorescent lamp (1); a display timing in a plural images (three images) display mode (2); the opening/closing timing of the optical shutter 13 in synchronization with the specific images in the plural images display mode (3); and the light amount of the fluorescent lamp transmitting in a time when the optical shutter 13 opens (4) are shown in this order.

In this case, a display cycle from a certain specific image to a next specific image (2) is changed to 1/100 second, and it is one time the flashing cycle of the fluorescent lamp, which is 1/100 second. As the result, the light amount which transmits the optical shutter 13 (4) is constant at any period in which the shutter opens, and the flicker is not generated.

FIG. 10 is a chart for showing a preferable example in a case when the exemplary embodiment of the invention is applied to a situation shown in FIG. 6. In FIG. 10; a waveform showing a change in brightness of the fluorescent lamp (1); a display timing in the plural images (three images) display mode (2); the opening/closing timing of the optical shutter 13 in synchronization with the specific images in the plural images display mode (3); and the light amount of the fluorescent lamp transmitting in a time when the optical shutter 13 opens (4) are shown in this order.

Here, a display cycle from a certain specific image to a next specific image (2) is changed to 1/25 second, and it is four times the flashing cycle of the fluorescent lamp, which is 1/100 second. In this case, the light amount which transmits the optical shutter 13 (4) is constant at any period in which the shutter opens. However, a light-dark cycle by the opening/closing of the optical shutter 13 becomes to be 1/25 second, which is too long, and this light-dark change is perceived as the flicker. Therefore, it is not preferable that the display cycle of the specific image becomes too long, and the cycle is preferable to be 1/50 second or less.

Consequently, it is preferable that the display cycle control device 17 sets the display cycle of the specific image to be either one of 1/50 second or 1/100 second when the flashing cycle detected by the flashing cycle detecting device 19 is 1/100 second, and sets the display cycle of the specific image to be either one of 1/60 second or 1/120 second when the flashing cycle is 1/120 second.

FIG. 11 shows an example of the case when the exemplary embodiment of the invention is applied to the stereoscopic image display mode shown in FIG. 7.

In FIG. 11; a waveform showing a change in brightness of the fluorescent lamp (1); a display timing of the left and right eye images in the stereoscopic image mode (2); the opening/closing timing of a right shutter in the stereoscopic image mode (3); the light amount of the fluorescent lamp transmitting the right shutter (4); the opening/closing timing of a left shutter in the stereoscopic image mode (5); the light amount of the fluorescent lamp transmitting the left shutter (6) are shown in this order.

In this case, a display cycle from a certain right eye image to a next right eye image (2) is changed to be 1/50 second, and it is twice the flashing cycle of the fluorescent lamp (2), which is 1/100 second. Accordingly, the light amount transmitted through the right eye side optical shutter shown in (4) and the light amount transmitted through the left eye side optical shutter shown in (6) become constant at any period during which each shutter opens, and the flicker is not generated.

FIG. 12 is a flowchart showing another processing routine according to the first exemplary embodiment of the invention. It shows a case in which the user directly inputs the image display cycle corresponding to the commercial power frequency and the like into the flashing cycle detecting device 19 or the display control device 11.

The normal image display mode is switched and set to the plural images sequential display mode (step S201). The plural images are displayed sequentially and repeatedly (step S202), and the optical shutter 13 is set to be opened in synchronization with the specific image among the plural images (step S203).

In this state, it is judged whether the user who is using the optical shutter recognizes the flicker or not (step S204). When the flicker is recognized, the image display cycle of the control device 10A is changed by inputting the commercial power frequency and the like directly (step S205). Then, proceeding returns to step S203 again, and after the opening/closing of the optical shutter 13 is synchronized with this image display cycle, it is judged whether the flicker is recognized or not in step S204. When the flicker is not recognized, proceeding proceeds to step S206 to hold the status quo.

When there remains a measurable flicker, a state in which the flicker is not generated can be realized by reducing further the image display cycle inputted directly by half or the like.

### Second Exemplary Embodiment

FIG. 13 is a block diagram showing a second exemplary embodiment of the present invention. As shown in FIG. 13, in the second exemplary embodiment of the present invention, a display system 20 is configured with a control device 20A, an optical shutter unit 23, and an optical sensor 24A. The second exemplary embodiment differs from the first exemplary embodiment shown in FIG. 1 in detecting the flashing cycle of the intermittent illumination 15 by using the optical sensor 24A, and accordingly changing the image display cycle.

The control device 20A is configured with a display control device 21 which performs display control, and a display panel 21A. The display control device 21 includes a main control device 22 which performs control of entire display system 20, a flashing cycle detecting device 24 which detects the fracture in brightness of the intermittent illumination 15, a display cycle control device 25 which controls the display cycle of the image displayed on the display panel 11A, an operation setting device 26 which sets the mode with which the image is displayed, from the normal image display mode and the plural images sequential display mode, and the like. Here, the exemplary embodiment is described with a case in which the display panel 11A is incorporated in the control device 20A. However, the invention is not limited to this, and the display panel 11A may be provided independently, separated from the control device 20A.

Further, the flashing cycle detecting device 24 includes a brightness fluctuation detecting device 241 which detects the fluctuation in brightness of the intermittent illumination 15 from an output of the optical sensor 24A such as a photodiode. The display cycle control device 25 includes an image display cycle changing device 251 which changes the image display cycle, and a synchronous signal transmitting device 253 which transmits the synchronous signal of the image display cycle to the optical shutter unit 23. The optical shutter unit 23 includes an optical shutter 233 which opens/closes in synchronization with the display of the specific image, a shutter opening/closing device 233A which drives the optical shutter 233, a shutter opening/closing control device 232 which controls the opening/closing timing, and a synchronous signal receiving device 231 which receives the synchronous signal from the synchronous signal transmitting device 253.

FIG. 14 is a flowchart showing a processing routine according to the second exemplary embodiment of the invention. An operation of the second exemplary embodiment will be explained according to FIG. 13 and FIG. 14.

A sequential display mode is set by setting from the operation setting device 26 and accordingly the normal display mode is switched to the plural images sequential display mode (step S301). With this, the plural images are displayed sequentially and repeatedly on the display panel 21A by the operation of the display cycle control device 25 (step S302: image display step).

Here, the flashing cycle detecting device 24 detects the flashing cycle of the intermittent illumination 15 from an output of the optical sensor 24A by using the brightness fluctuation detecting device 241 (step S303: flashing cycle detecting step). Next, the main control device 22 judges whether the current specific image display cycle is equal to an integer multiple of the flashing cycle of the intermittent illumination 15 or not (step S304).

When the current specific image display cycle is not equal to an integer multiple of the flashing cycle, the image display cycle is changed by the image display cycle changing device 251 (step S305: image display cycle adjusting step).

In step S304, when the specific image display cycle is equal to an integer multiple of the flashing cycle, display cycle control device 25 transmits a synchronous signal from the synchronous signal transmitting device 253 in synchronization with the specific image among the plural images, and the optical shutter unit 23 receives the synchronous signal by the synchronous signal receiving device 231 and opens the optical shutter 233 in synchronization with the specific image by operating the shutter opening/closing control device 232 and the shutter opening/closing device 233A (step S306: optical shutter opening/closing control step).

With this processing routine, the opening/closing cycle of the optical shutter is set equal to an integer multiple of the flashing cycle of the intermittent illumination in the second exemplary embodiment, and the light amount of the intermittent illumination transmitting through the optical shutter becomes constant within each opening period of the optical shutter, thus the flicker is not generated. Compared to the first exemplary embodiment, the generation of the flicker can be suppressed reliably even when the commercial power frequency is unknown or when the display device is driven by a buttery without using the commercial power source, since the second exemplary embodiment detects the flashing cycle of the intermittent illumination by using the optical sensor. Further, the flicker can be eliminated effectively with regard to a light source which is an intermittent illumination different from the fluorescent lamp and flashes unrelated to the commercial power frequency.

In the step S303 of the flowchart shown in FIG. 14, for detecting the flashing cycle of the intermittent illumination 15 from the output of the optical sensor 24A by using the brightness fluctuation detecting device 241, the optical sensor 24A is arranged at a position where the illumination light from the intermittent illumination 15 can be received. In this regard, when a reflection type or a transflective type display panel is used as the display panel 21A, the optical sensor 24A may be arranged at a position where the reflected light from the display panel 21A can be received.

Here, the brightness detected in step S303 may be illuminance or luminance. Also, other than the method for starting the brightness detection and display cycle control after the mode is switched to the plural images display mode, it may be acceptable to employ a method in which a detection result of the flashing cycle of the intermittent illumination 15 which had been detected in advance is applied just after the mode is switched to the plural images display mode.

FIG. 15 is a block diagram showing another configuration of the second exemplary embodiment of the invention.

A display system 30 is configured with a control device 30A, an optical shutter unit 33, and an optical sensor 36A. This example differs from the first exemplary embodiment and the example shown in FIG. 13 in that a flashing cycle detecting device 36 which detects the fluctuation in brightness and the like is incorporated in the optical shutter unit 33.

The optical shutter unit 33 is configured with the flashing cycle detecting device 36, an optical shutter 39 which opens/closes in synchronization with the display of the specific image, a shutter opening/closing device 39A which drives the opening/closing of the optical shutter 39, a shutter opening/closing control device 38 which controls the opening/closing timing, and a display synchronous signal receiving device 37 which receives the display synchronous signal from the control device 30A.

The flashing cycle detecting device 36 is configured with a brightness fluctuation detecting device 361 which detects the fluctuation in brightness of the intermittent illumination 15 from an output of the optical sensor 36A and a flashing synchronous signal transmitting device 363 which transmits a flashing synchronous signal obtained from the detection result to the control device 30A.

The control device 30A is configured with a display control device 31 which performs display control, and a display panel 31A. The display control device 31 includes a main control device 32 which performs control of entire display system 30, a display cycle control device 34 which controls the display on the display panel 31A, and an operation setting device 35 which sets the operation of the display system 30. Here, the exemplary embodiment is described with a case in which the display panel 31A is incorporated in the control device 30A. However, the invention is not limited to this, and the display panel 31A may be provided independently, separated from the control device 30A.

The display cycle control device 34 includes a flashing synchronous signal receiving device 341 which receives the flashing synchronous signal corresponding to the fluctuation in brightness of the intermittent illumination 15 transmitted from the flashing synchronous signal transmitting device 363 of the optical shutter unit 33, an image display cycle changing device 342 which changes the image display cycle, and a display synchronous signal transmitting device 344 which transmits the display synchronous signal indicating the image display cycle to a display synchronous signal receiving device 37 of the optical shutter unit 33.

At the flashing cycle detecting device 36, the result detected by the brightness fluctuation detecting device 361, receiving an output of the optical sensor 36A, is transmitted to the display control device 31 by the flashing synchronous signal transmitting device 363, and received by the flashing synchronous signal receiving device 341 of the display cycle control device 34. Based on this, the image display cycle changing device 342 changes the image display cycle appropriately, then the result is transmitted to the display synchronous signal receiving device 37 of the optical shutter unit 33 by the display synchronous signal transmitting device 344, and based on this, the shutter opening/closing control device 38 opens/closes the optical shutter 39 by the shutter opening/closing device 39A under an appropriate condition.

According to this exemplary embodiment, since the flashing cycle of the intermittent illumination is detected directly, the generation of the flicker can be suppressed reliably. Further, the flashing cycle detecting device and the like can be arranged at a position suited for detection, or a position the device can be easily mounted, so the configuration of the display system can be changed appropriately according to the purpose to be used for. The optical sensor 36A is arranged at a position where the illumination light from the intermittent illumination 15 can be received. In this regard, when a reflection type or a transflective type display panel is used as the display panel 21A, the optical sensor 36A may be arranged at a position where the reflected light from the display panel 21A can be received.

Further, the optical sensor 36A may be a transmitting light detecting device arranged at a position where the brightness of the light transmitting through the optical shutter 39 can be detected. The image display cycle for suppressing the flicker may be determined optimally by using a method of detecting the flicker directly from the light transmitting through the optical shutter 39 and, for example, changing the image display cycle sequentially.

FIG. 16 is a block diagram showing still another configuration of the second exemplary embodiment of the invention.

In this example, a display system 40 is configured with a control device 40A, an optical shutter unit 44, an external device 43, and an optical sensor 46A. This example differs from the first exemplary embodiment and the examples shown in FIG. 13 and FIG. 15 in that a flashing cycle detecting device 46 which detects the brightness of the intermittent illumination 15 and a part of the function of the display cycle control device which controls the display on the display panel 41A (display cycle control device (a) 47) are incorporated in the external device 43 which is arranged as another casing. For the rest, this example operates similarly as the first exemplary embodiment and the examples shown in FIG. 13 and FIG. 15. Here, the exemplary embodiment is described with a case in which the display panel 41A is incorporated in the control device 40A. However, the invention is not limited to this, and the display panel 41A may be provided independently, separated from the control device 40A.

The flashing cycle detecting device 46 detects the fluctuation in brightness of the intermittent illumination 15 with the brightness fluctuation detecting device 461 by using an optical sensor 46A and inputs it to the display cycle control device (a) 47. When a reflection type or a transflective type display panel is used as the display panel 41A, the image brightness detecting device for detecting the flashing cycle by receiving the reflected light from the display panel 41A may be arranged.

The display cycle control device (a) 47 creates an appropriate display control signal by using an image display cycle changing device (a) 471, and transmits the signal to the display control device 41 via a display control signal transmitting device 473.

In the display control device 41, the display cycle control device (b) 45 receives the display control signal by using the display control signal receiving device 451, and changes the image display cycle by using an image display cycle changing device (b) 452. The synchronous signal of the changed image display cycle is transmitted, from the display synchronous signal transmitting device (a), to the display synchronous signal receiving device (b) 441 of the optical shutter unit 44, directly, or via the display signal receiving device (a) 481 and the display synchronous signal transmitting device (b) of the display synchronous signal transmitting/receiving unit 48 incorporated in the external device 43.

The optical shutter unit 44 includes the display synchronous signal receiving device (b) 441 which receives the display synchronous signal, a shutter opening/closing control device 442 which controls the opening/closing timing of the optical shutter 443, and a shutter opening/closing device 443A which drives the optical shutter 443.

According to this exemplary embodiment, since the flashing cycle of the intermittent illumination is detected directly, the generation of the flicker can be suppressed reliably. And further, a plurality of the display devices and optical shutter units can be controlled by a single external device.

### Third Exemplary Embodiment

FIG. 17 is a block diagram showing an example of a third exemplary embodiment of the invention.

A display system 50 is configured with a control device 50A, an optical shutter unit 53, and an optical sensor 54A. The third exemplary embodiment differs from the second exemplary embodiment shown in FIG. 13 in that the display start timing of a display panel 51A is changed by using a flashing phase detecting device 542 and an image display starting point changing device 552, and accordingly the phase of the opening period of the optical shutter 533 is adjusted. For the rest, this example operates similarly as the second exemplary embodiment. Here, the exemplary embodiment is described with a case in which the display panel 51A is incorporated in the control device 50A. However, the invention is not limited to this, and the display panel 51A may be provided independently, separated from the control device 50A.

FIG. 18 is a schematic explanatory diagram showing an overall configuration when a reflection type or a transflective type display panel is used as the display panel 51A, and FIG. 19 is a schematic explanatory diagram showing an overall configuration when a display panel of a transmission type, a transflective type in transmission mode, a projection type, or a light emitting type is used as the display panel 51A.

When the reflection type display panel 51A or the transflective type display panel 51A in reflection mode is used, the display screen is more easily viewable as the illumination is brighter. However, if the optical shutter 533 opens at the time when the flashing of the intermittent illumination is being dark, the screen decreases in brightness, because a person using the optical shutter 533 recognizes the image by utilizing the reflection light of the intermittent illumination 15. Also, the surrounding such as around the user decreases in brightness.

On the other hand, when the display panel 51A of the transmission type, the transflective type in transmission mode, the projection type, or the light emitting type is used, the illumination is reflected on the display screen, and the display screen is more easily viewable sometimes as the illumination is darker. It is remarkable in particular in a case of a front projector used for the movie or the like, in which the contrast of the image is lowered if the screen becomes brighter by the luminance.

This exemplary embodiment makes it possible to optimize the viewability of the display image in accordance with the above-described types of the display panels.

FIG. 20 is a flowchart showing a processing routine according to the third exemplary embodiment. When the normal display mode is switched to the plural images sequential display mode by setting of the operation setting device 56 (step S401), the plural images are displayed sequentially and repeatedly on the display panel 51A (step S402: image display step).

Here, a brightness fluctuation detecting device 541 of the flashing cycle detecting device 54 detects the brightness of the intermittent illumination 15 and the flashing cycle of the intermittent illumination 15 is detected from the fluctuation in brightness (step S403: flashing cycle detecting step).

Next, the main control device 52 judges whether the current specific image display cycle is an integer multiple of the flashing cycle of the illumination or not (step S404).

When the current specific image display cycle is not an integer multiple of the flashing cycle, the image display cycle is changed by the image display cycle changing function 551 of the display cycle control device 55 (step S405: image display cycle adjusting step).

In step S404, when the specific image display cycle is an integer multiple of the flashing cycle of the illumination, it is detected whether a phase shift is present between an objected brightness area of the intermittent illumination and the opening period of the optical shutter 533 in this state (step S406). When there is the phase shift, the timing of starting the image display is adjusted such that the light amount transmitting the optical shutter 533 becomes optimum by operating the image display starting point changing device 552 of the display cycle control device 55 (step S407).

The “objected brightness area” in this case is described later.

In step S406, when there is no phase shift between the objected brightness area and the opening period of the optical shutter 533, proceeding proceeds to step S408, a synchronous signal is transmitted from the synchronous signal transmitting device 553 to the synchronous signal receiving device 531 of the optical shutter unit 53 in synchronization with the image cycle, and the optical shutter 533 is opened in synchronization with the specific image display cycle via a shutter opening/closing control device 532 (step S408: optical shutter opening/closing control step).

FIG. 21 shows an example of the display timing in a case that the exemplary embodiment of the invention is applied to a configuration shown in FIG. 17. It is the example in which a reflection type or a transflective type display panel is used as the display panel 51A.

FIG. 21 shows; a waveform showing a change in brightness of the fluorescent lamp (1); a display timing in a plural images (three images) display mode (2); the open/close timing of the optical shutter 533 in synchronization with the specific images in the plural images display mode (3); and the light amount of the fluorescent lamp transmitting in a time when the optical shutter 533 opens (4).

In this case, a display cycle from a certain specific image to a next specific image (2) is 1/60 second, and it is twice the flashing cycle of the fluorescent lamp, which is 1/120 second. Thus, the phase difference between the timing of starting the specific image display and a peak position of the brightness of the fluorescent lamp is adjusted such that the light amount transmitting the optical shutter becomes a maximum. As the result, the light amount transmitting the optical shutter shown in (4) becomes constant at the position where the light amount becomes a maximum in any period during which the shutter opens, and the user of the optical shutter can recognizes a bright image on the display panel of the reflection type or the transflective type visually.

The “objected brightness area” described above means the peak position of the brightness of the fluorescent lamp in this example.

FIG. 22 shows an example of the display timing in a case that the exemplary embodiment of the invention is applied to a configuration shown in FIG. 18. In the example shown in FIG. 22, a display panel of a transmission type, a transflective type in transmission mode, a projection type, or a light emitting type is used as the display panel 51A.

FIG. 22 shows; a waveform of the AC power source voltage for lighting the fluorescent lamp (1); a waveform showing a change in brightness of the fluorescent lamp (2); a display timing of the normal display (3); a display timing in a plural images (three images) display mode (4); the opening/closing timing of the optical shutter 63 in synchronization with the specific images in the plural images display mode (5); and the light amount of the fluorescent lamp transmitting in a time when the optical shutter 63 opens (6).

In this case, a display cycle from a certain specific image to a next specific image (4) is 1/60 second, and it is twice the flashing cycle of the fluorescent lamp, which is 1/120 second. Thus, the phase difference between the timing of starting the specific image display and a bottom position of the brightness of the fluorescent lamp is adjusted such that the light amount transmitting the optical shutter becomes a minimum. As the result, the light amount of the fluorescent lamp transmitting the optical shutter shown in (6) becomes constant at the position where a value of integral of the light amount becomes a minimum in any period during which the shutter opens, and the affection of the illumination to the display image can be minimized.

The “objected brightness area” means the bottom position of the brightness of the fluorescent lamp in this example. Needless to say, the “objected brightness area” is not limited to the peak position and the bottom position of the brightness of the fluorescent lamp, and it may be set at any desired position. Thus, the generation of the flicker can be prevented even under the intermittent illumination such as the fluorescent lamp, and it is possible to optimize the viewability of the display image in accordance with the types of the display panels.

### Fourth Exemplary Embodiment

Patent Document 1 of the background art discloses a technique with which only the user of the optical shutter can view a normal image such as a secret image, and a person who doesn't use the optical shutter is not presented with a usable image information. A fourth exemplary embodiment of the invention describes an example to which a technique of the present invention is applied, where the specific image among the plural images is set to be a black image which is displayed on the entire screen, and a valid image such as a secret image is set to be displayed as the other image, and then a person who doesn't use the optical shutter can view the secret image and the other people are prevented from viewing the secret image by the optical shutter.

FIG. 23 explains a display system according to the fourth exemplary embodiment of the invention. It shows an example to be applied to an ATM terminal in a bank.

A display system 200 of the fourth exemplary embodiment is configured with a control device 210A which displays the plural images by switching sequentially, and an optical shutter 213 which repeats open/close operations in synchronization with the specific image from among the images sequentially displayed.

The control device 210A includes a display panel 211A and a display control device, not shown, which performs display control (for example, corresponding to the display control device 10A of the first exemplary embodiment). Further, the display control device includes a main control device which performs control of entire display system 200 (for example, corresponding to the main control device 11 of the first exemplary embodiment), a flashing cycle detecting device which detects a flashing cycle and a phase of the intermittent illumination 215 (for example, corresponding to the flashing cycle detecting device 19 of the first exemplary embodiment), and a display cycle control device which controls the display cycle of the image displayed on the display panel 211A (for example, corresponding to the display cycle control device 17 of the first exemplary embodiment).

The optical shutter 213 is placed on a door 201 to the room in which the ATM terminal is installed. The optical shutter 213 includes a shutter opening/closing device which drives the optical shutter 213 and a shutter opening/closing control device which controls the opening/closing timing of the optical shutter 213, which are not shown.

At the ATM terminal, the user doesn't want to be viewed the secret information displayed on the display screen 211A by the others. Also, wearing the eyeglasses as shown in FIG. 2 is bothersome, and further, unsanitary because general majority wears it. On the other hand, there is such a requirement that the others can see inside the room from outside the door 201, for reasons of utilization and crime prevention.

In the fourth exemplary embodiment of the invention, the black image is displayed as the specific image on the entire screen of the display panel 211A, and 1D number entry screen or an image of a valid information concerning to a transaction is displayed for the other image. These images are displayed in synchronization with the flashing cycle of the intermittent illumination 15, and also, the display cycle control device 210A controls these images in such a manner that the black image is displayed on the entire screen when the intermittent illumination 15 is being bright and the valid information image is displayed when the intermittent illumination 15 is being dark. Also, the optical shutter 213 is driven by the shutter opening/closing control device which controls the opening/closing timing and the shutter opening/closing device so as to be in a state in which the light is transmitted when the black image is displayed on the display panel 211A as the specific image, and in a state in which the light is not transmitted the light when the valid information image is displayed. That is, the optical shutter 213 transmits the light when the intermittent illumination 15 is being bright, and does not transmit the light when the intermittent illumination 15 is being dark.

For the user being inside the door 201, i.e., the user being between the display panel 211A and the optical shutter 213, the black image and the valid information image are presented alternatively on the display panel 211A, and the valid information image is recognized as an image as the result of integration with respect to time.

On the other hand, from the others outside the door 201, only the black image is viewed on the display panel 211A. That is, the valid information is not viewed by the others. Also, the situation inside the room other than the image displayed on the display panel 211A can be viewed brightly. Since the intermittent illumination 15 and the optical shutter 213 are synchronized with each other, the flicker is not generated.

As described above, the display system with which the secret image is viewable to the user by not using the optical shutter, and is not viewable to the others by using the optical shutter, is realized without generating the flicker, according to the exemplary embodiment.

This exemplary embodiment is not applies only to the ATM terminal. For example, when it is a case of a conference room, it can apply to a display system, to realize such a system which enables a person to confirm that the conference room is used from outside, but prevents the person from viewing the information discussed inside, and further various applications are possible.

### Fifth Exemplary Embodiment

FIG. 24 is a block diagram showing a fifth exemplary embodiment of the invention. A display system 100 of the fifth exemplary embodiment is configured with a control device 100A which displays plural images by switching sequentially, an optical shutter 13 which repeats open/close operations in synchronization with the specific image among the images displayed sequentially, a shutter opening/closing device 13A which drives the optical shutter 13, a shutter opening/closing control device 18 which controls the opening/closing timing of the optical shutter 13. Also, the control device 100A includes a display control device 11 which performs display control, and a display panel 11A. Further, the display control device includes a main control device 12 which performs control of entire display system 100, a display cycle control device 17 which controls the display cycle of the image displayed on the display panel 11A, and a flashing cycle detecting device 109 which detecting the flashing cycle of the intermittent illumination 15. Here, the exemplary embodiment is described with a case in which the display panel 11A is incorporated in the control device 100A. However, the invention is not limited to such a case, and the display panel 11A may be provided independently, separated from the control device 100A.

The fifth exemplary embodiment differs from the first exemplary embodiment shown in FIG. 1 in that the flashing cycle control device 109 is used in place of the flashing cycle detecting device 19, to control the flashing cycle of the intermittent illumination 15. For the rest, this example operates similarly as the first exemplary embodiment shown in FIG. 1.

When the display cycle of the specific image, i.e., the opening/closing cycle of the optical shutter 13 is set equal to an integer multiple of the flashing cycle of the intermittent illumination 15, the light amount of the intermittent illumination 15 transmitting through the optical shutter 13 becomes constant within each opening period of the optical shutter, and the flicker is not generated.

To realize this, the first exemplary embodiment to the fourth exemplary embodiment detect the flashing cycle of the intermittent illumination 15, and control the display cycle of the specific image displayed on the display panel 11A based on the flashing cycle by using the display cycle control device 17.

In the fifth exemplary embodiment, the flashing cycle of the intermittent illumination 15 is controlled by the flashing cycle control device 109 in such a manner that the display cycle of the specific image is set equal to an integer multiple of the flashing cycle of the intermittent illumination 15. That is, a synchronous signal for the flashing cycle of the intermittent illumination, which is set based on the display cycle of the specific image, is transmitted from the main control device 12 to the flashing cycle control device 109, and the intermittent illumination 15 is driven in synchronization with this.

The flashing cycle of the intermittent illumination 15 can be changed, in a case of the fluorescent lamp for example, by converting the alternating current from the commercial AC source to the direct current by a rectification circuit, converting it to an alternate current of another frequency by an inverter provided, to change the frequency of the alternate current. Also, in a case of an LED light source, it can be changed by making the LED to be a pulse lighting type, and changing the frequency of the pulse. The synchronous signal for controlling may be transmitted by any one of wired, wireless, or infrared transmission.

Other than the method with which the display cycle of the specific image on the display panel is set to be constant and the flashing cycle of the intermittent illumination is synchronized with the cycle, a method with which the display cycle of the specific image is modulated with respect to time and the flashing cycle of the intermittent illumination follows the change may be employed. In this case, if the others intend to spy on the display panel by using an optical shutter which opens/closes at a constant interval, it is not possible to synchronize with the display cycle, so the confidentiality of the specific image can be enhanced.

This exemplary embodiment is explained as having such a configuration that the flashing cycle control device 109 is used in place of the flashing cycle detecting device 19 of the first exemplary embodiment shown in FIG. 1. However, when this replacement is applied to the third and fourth exemplary embodiments, the same effect as that of the first exemplary embodiment can be obtained. That is, it is only necessary to provide the flashing phase changing device 110 to the flashing cycle control device for a configuration in which the flashing cycle of the intermittent illumination is detected and the display cycle and the phase of the specific image to be displayed on the display panel is controlled by the display cycle control device based on the detected flashing cycle, and apply the control to optimize the flashing cycle and the phase of the intermittent illumination based on the display cycle of the specific image.

The exemplary embodiments of the invention use the display panel as the display device, but the invention is not limited only to such a case. The display device can be any devices other than the display panel as long as the device can display two or more images including the specific image sequentially and repeatedly. Also, the exemplary embodiment has a configuration in which the intermittent illumination is not included in the control device, but the control device may include the intermittent illumination. Further, the image display cycle changing device (a) and the image display cycle changing device (b) are a first image display cycle changing device and a second image display cycle changing device; the image synchronous signal transmitting device (a) and the image synchronous signal transmitting device (b) are a first image synchronous signal transmitting device and a second image synchronous signal transmitting device; and the image synchronous signal receiving device (a) and the image synchronous signal receiving device (b) are a first image synchronous signal receiving device and a second image synchronous signal receiving device.

In the explanation above, the display system and the specific image display method for the display system of the invention are described, but an execution content of each step of the specific image display method may be put into programs to be executed by a computer. With this, the same image display effect as that of the above described method can be obtained.

While the invention has been described with reference to exemplary embodiments (and examples) thereof, the invention is not limited to these embodiments (and examples). Various changes in form and details which are understood by those skilled in the art may be made within the scope of the present invention.

The present application claims priority based on Japanese Patent Application No. 2006-303399 filed on Nov. 8, 2006, the entire disclosure of which is incorporated herein.

### INDUSTRIAL APPLICABILITY

This invention has a possibility to be broadly used in industry fields such as an information processing terminal and an information communication.

### BRIEF DESCRIPTION OF THE DRAWINGS

FIG. 1 is a block diagram showing a structure of a first exemplary embodiment of the invention;

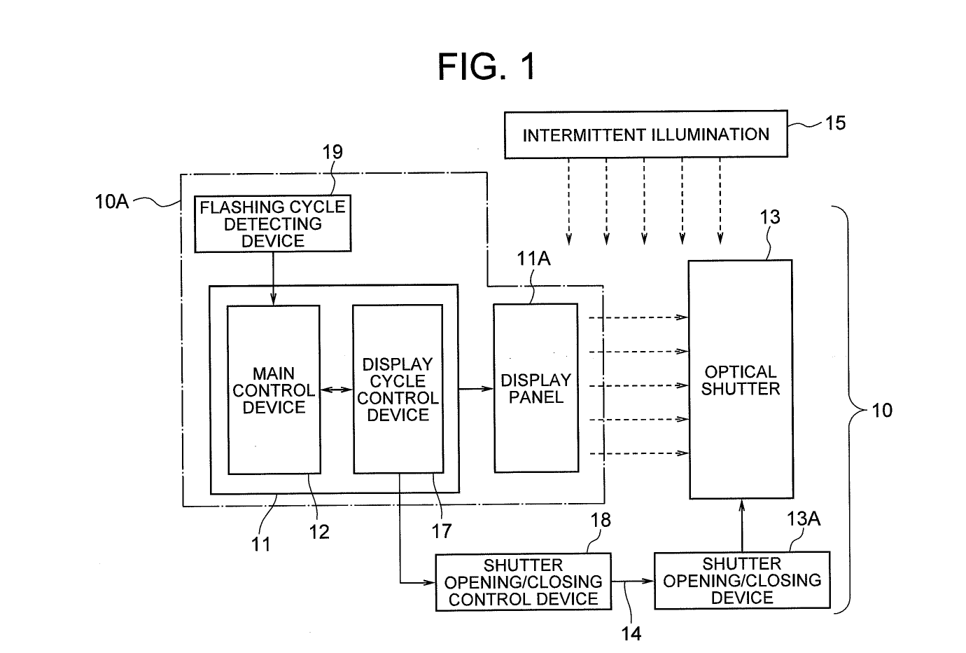

FIG. 2 is an explanatory diagram showing a schematic structure of the exemplary embodiment shown in FIG. 1;

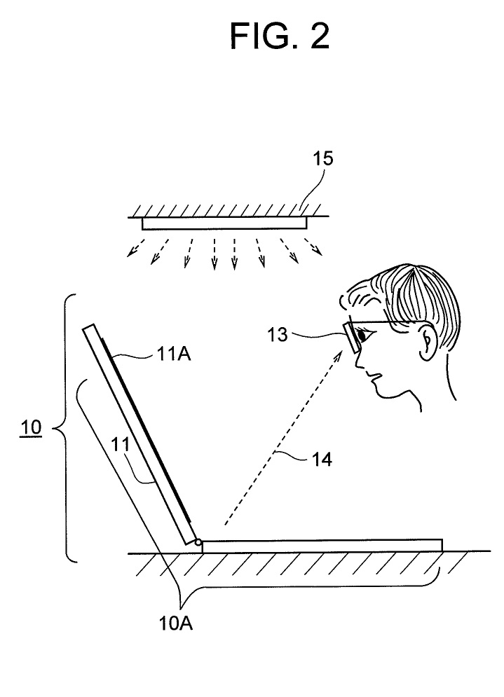

FIG. 3 is a flowchart showing a processing operation of the exemplary embodiment shown in FIG. 1;

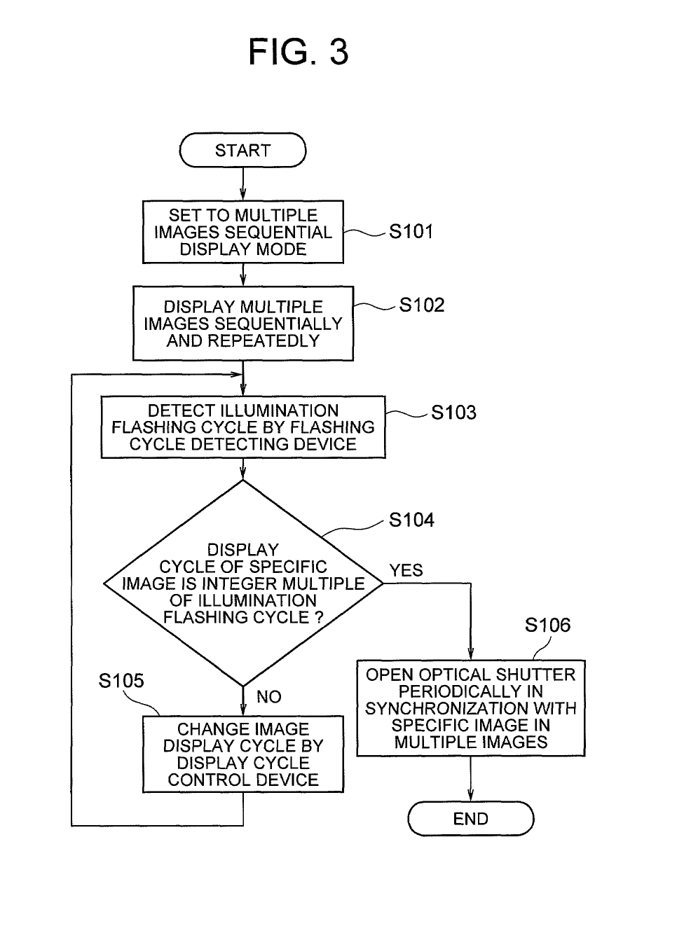

FIG. 4 is a timing chart showing a waveform of each part and timing thereof in a plural images display mode according to the exemplary embodiment shown in FIG. 1;

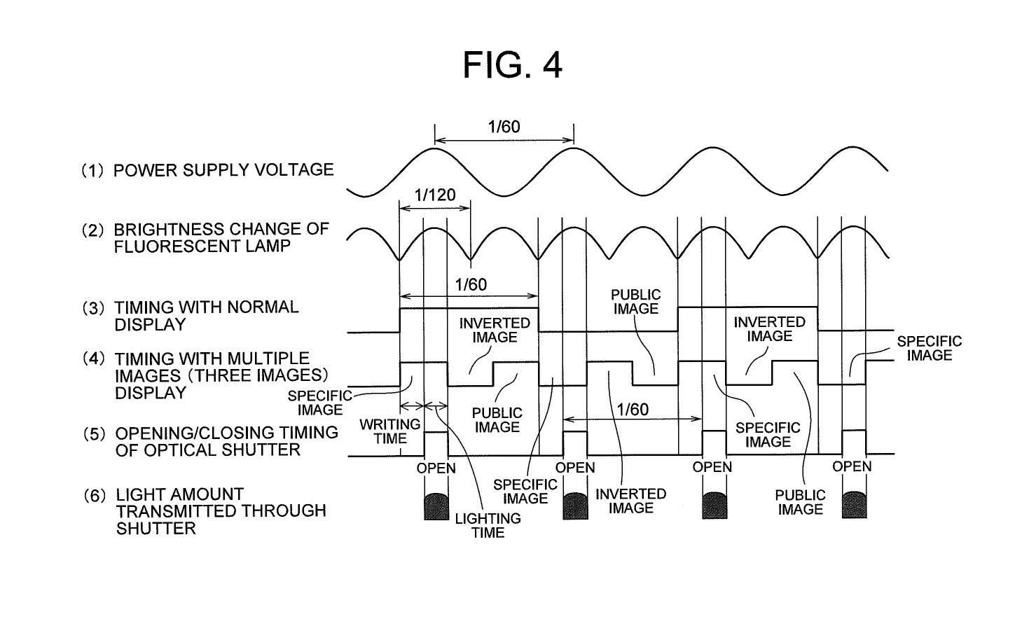

FIG. 5 is a timing chart showing a waveform of each part and timing thereof in a stereoscopic image display mode according to the exemplary embodiment shown in FIG. 1;

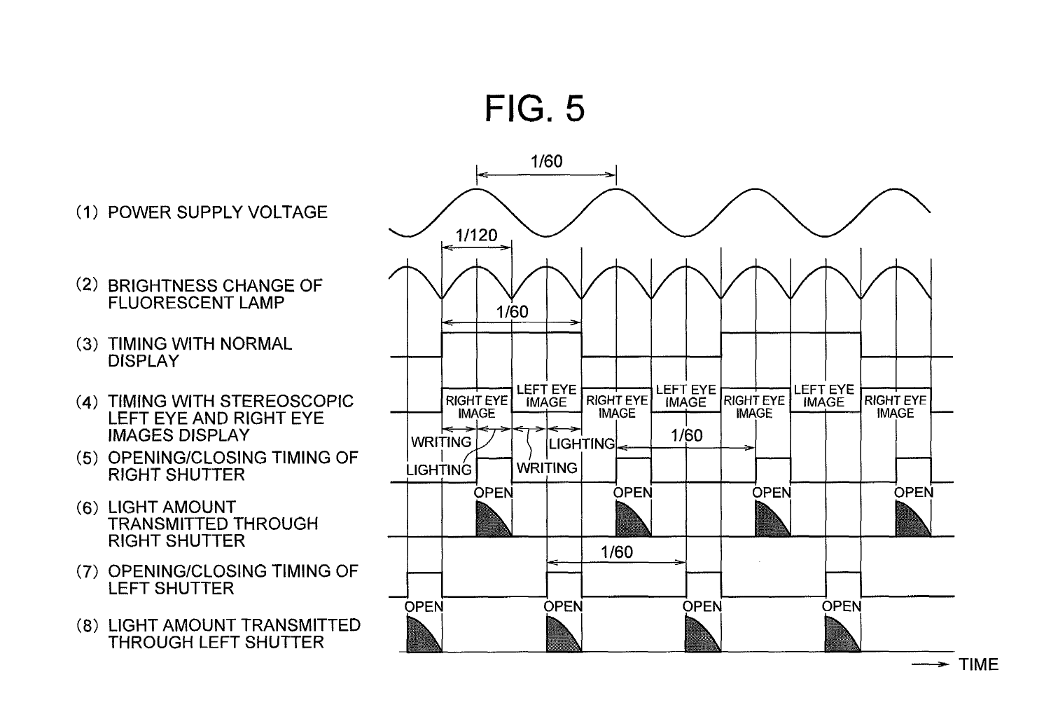

FIG. 6 is a timing chart showing a waveform of each part and timing thereof for describing a problem raised when a flashing cycle of an intermittent illumination is changed in the plural images display mode according to the exemplary embodiment shown in FIG. 1;

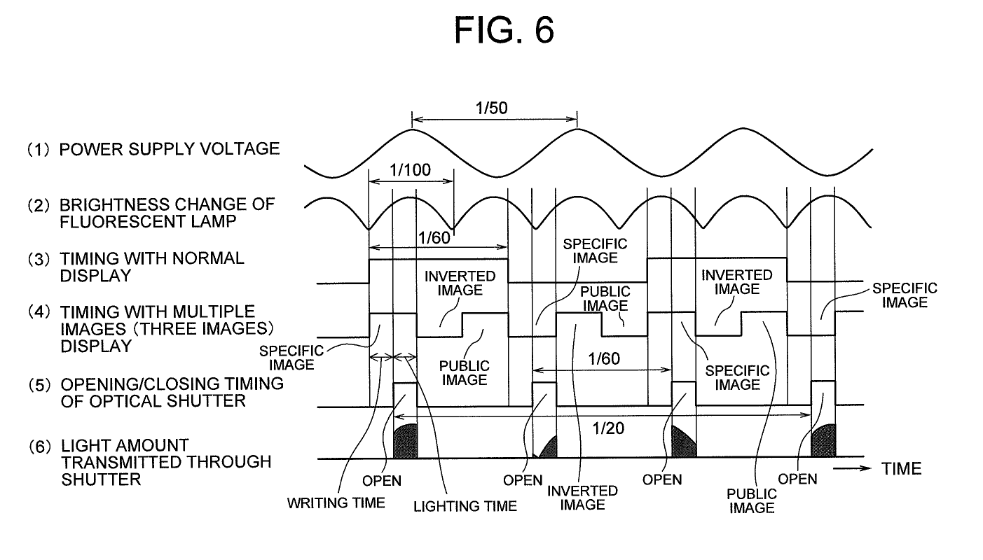

FIG. 7 is a timing chart showing a waveform of each part and timing thereof for describing a problem raised when the flashing cycle of the intermittent illumination is changed in the stereoscopic image display mode according to the exemplary embodiment shown in FIG. 1;

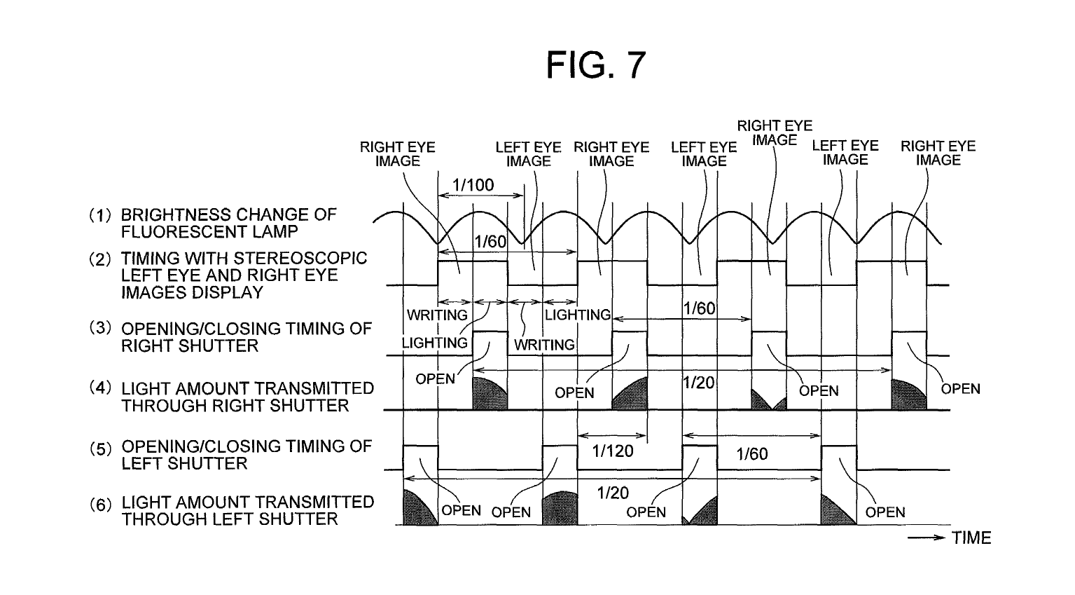

FIG. 8 is a timing chart showing a waveform of each part and timing thereof when the display cycle is changed corresponding to the change in flashing cycle of the intermittent illumination in the plural images display mode according to the exemplary embodiment shown in FIG. 1;

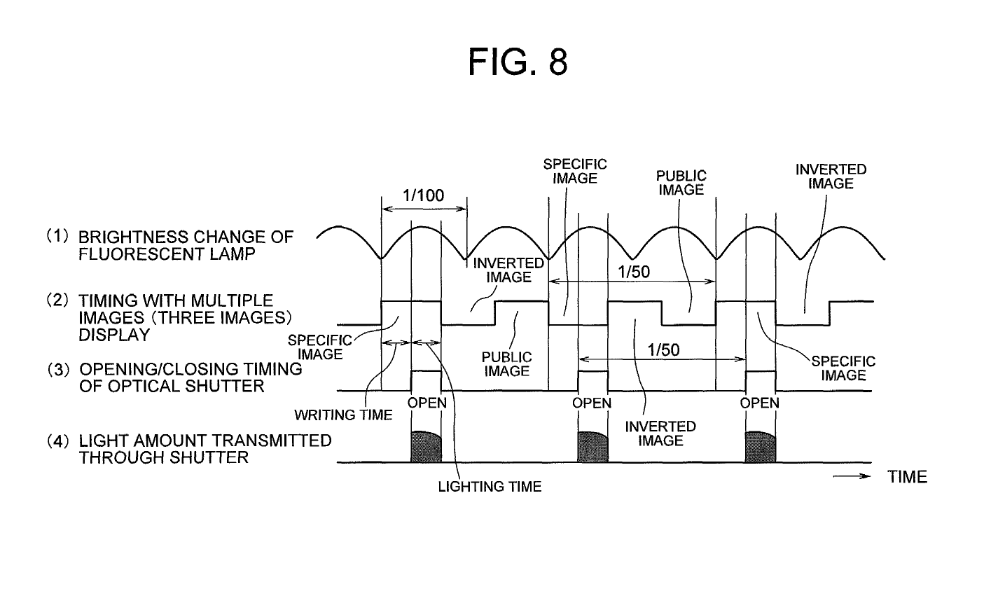

FIG. 9 is a timing chart showing a waveform of each part and timing thereof when the display cycle is changed corresponding to the change in flashing cycle of the intermittent illumination in the plural images display mode according to the exemplary embodiment shown in FIG. 1;

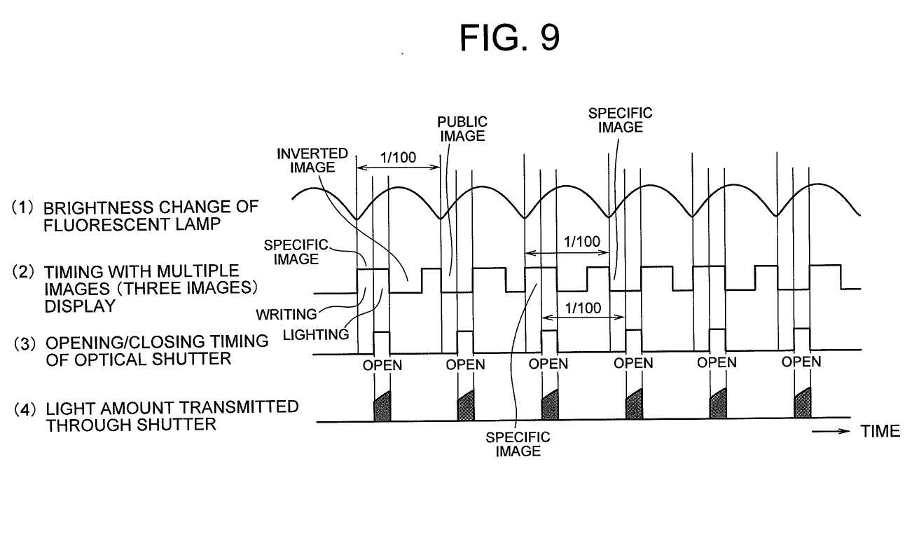

FIG. 10 is a timing chart showing a waveform of each part and timing thereof for describing a preferred example when the display cycle is changed corresponding to the change in flashing cycle of the intermittent illumination in the plural images display mode according to the exemplary embodiment shown in FIG. 1;

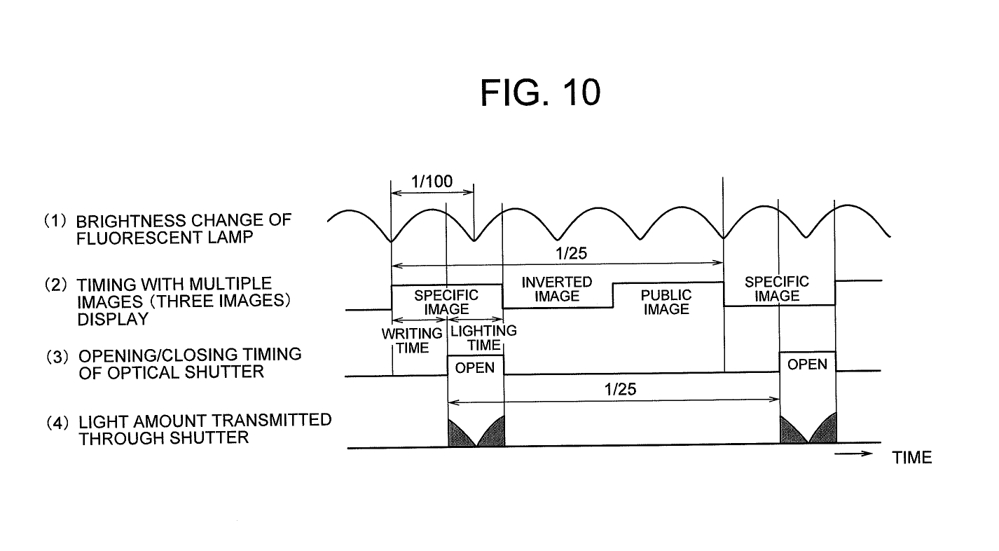

FIG. 11 is a timing chart showing a waveform of each part and timing thereof when the display cycle is changed corresponding to the change in flashing cycle of the intermittent illumination in the stereoscopic images display mode according to the exemplary embodiment shown in FIG. 1;

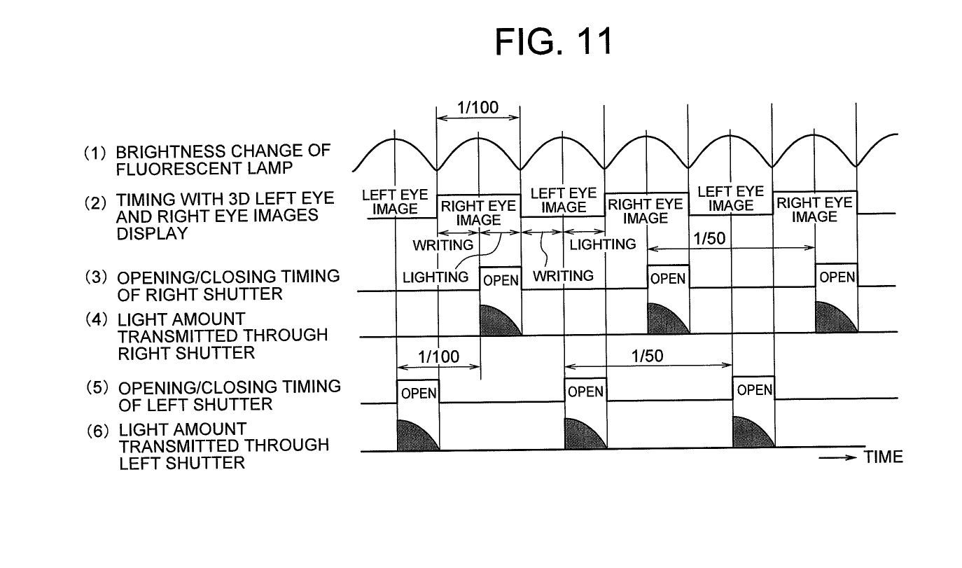

FIG. 12 is a flowchart showing another processing operation of the exemplary embodiment shown in FIG. 1;

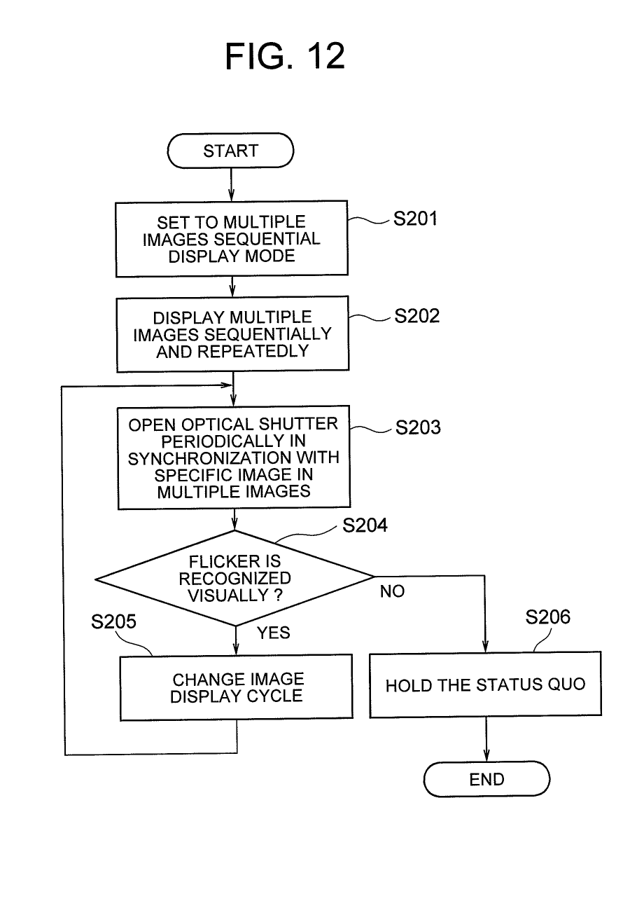

FIG. 13 is a block diagram showing a structure of a second exemplary embodiment of the invention;

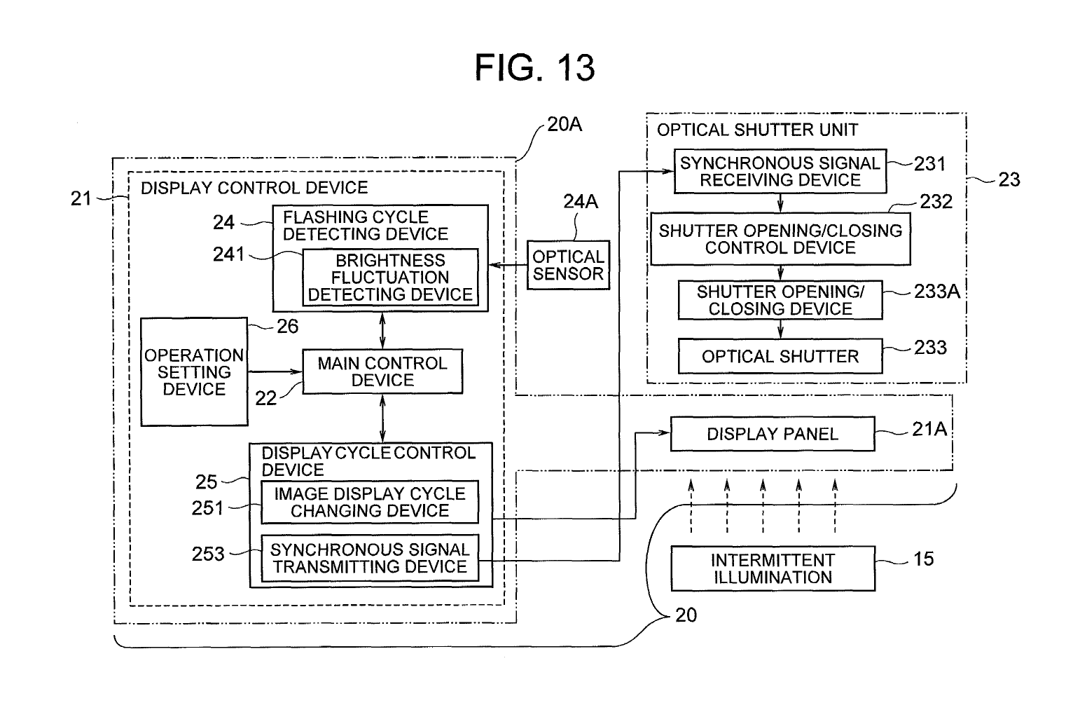

FIG. 14 is a flowchart showing a processing operation of the exemplary embodiment shown in FIG. 13;

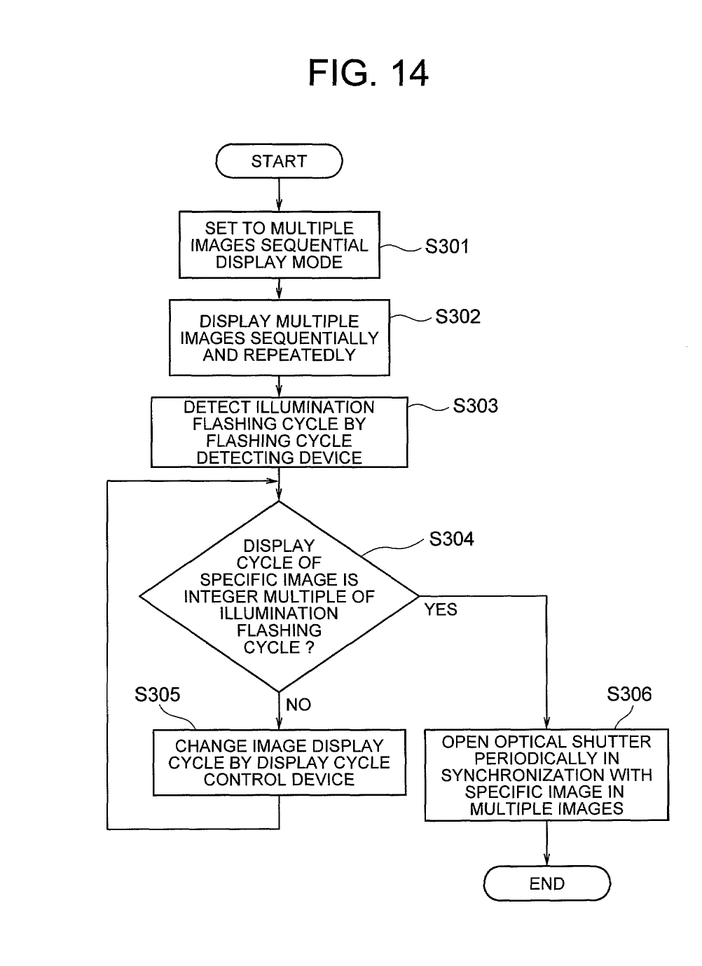

FIG. 15 is a block diagram showing another structure of the exemplary embodiment shown in FIG. 13;

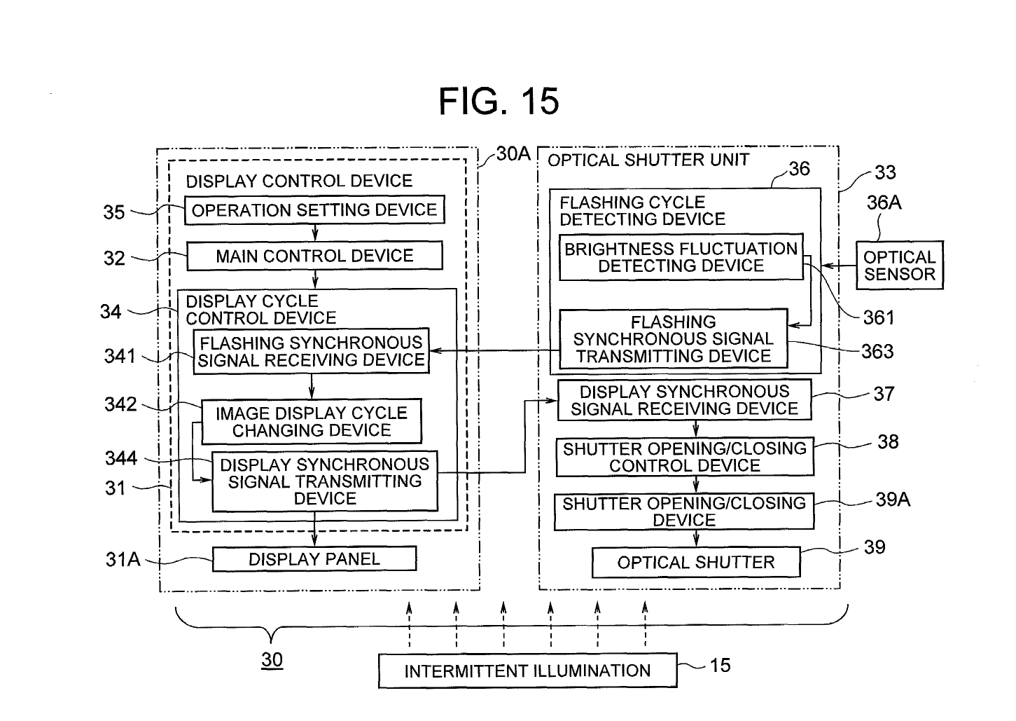

FIG. 16 is a block diagram showing still another structure of the exemplary embodiment shown in FIG. 13;

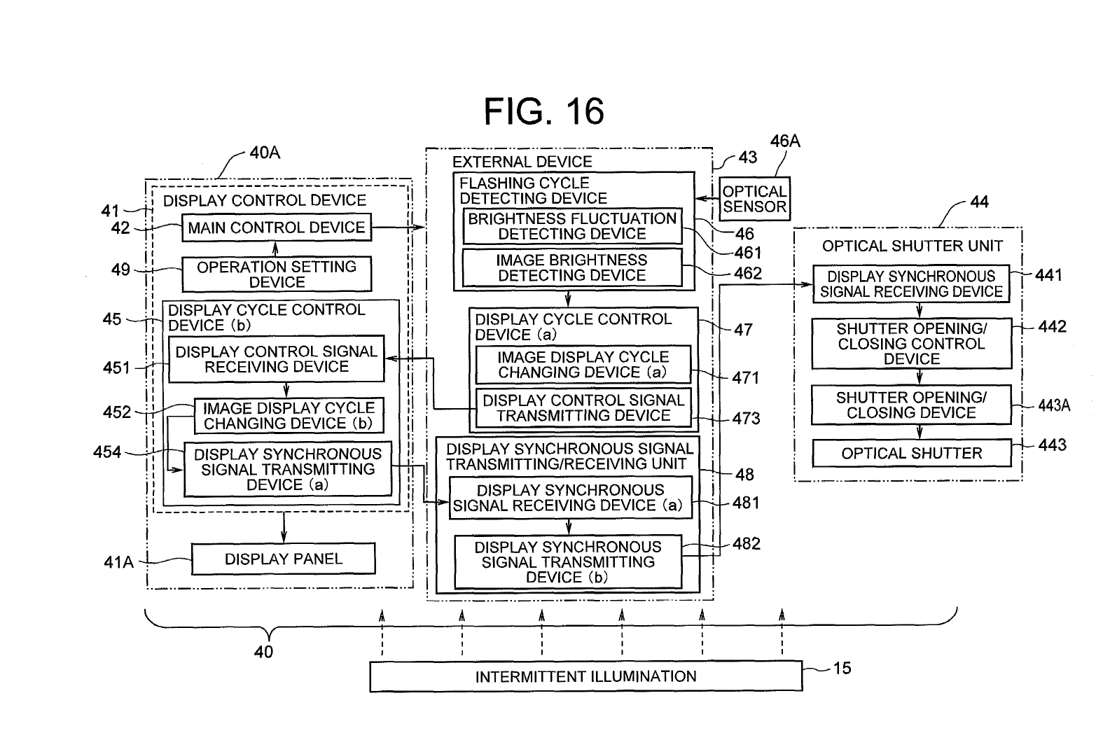

FIG. 17 is a block diagram showing a structure of a third exemplary embodiment of the invention;

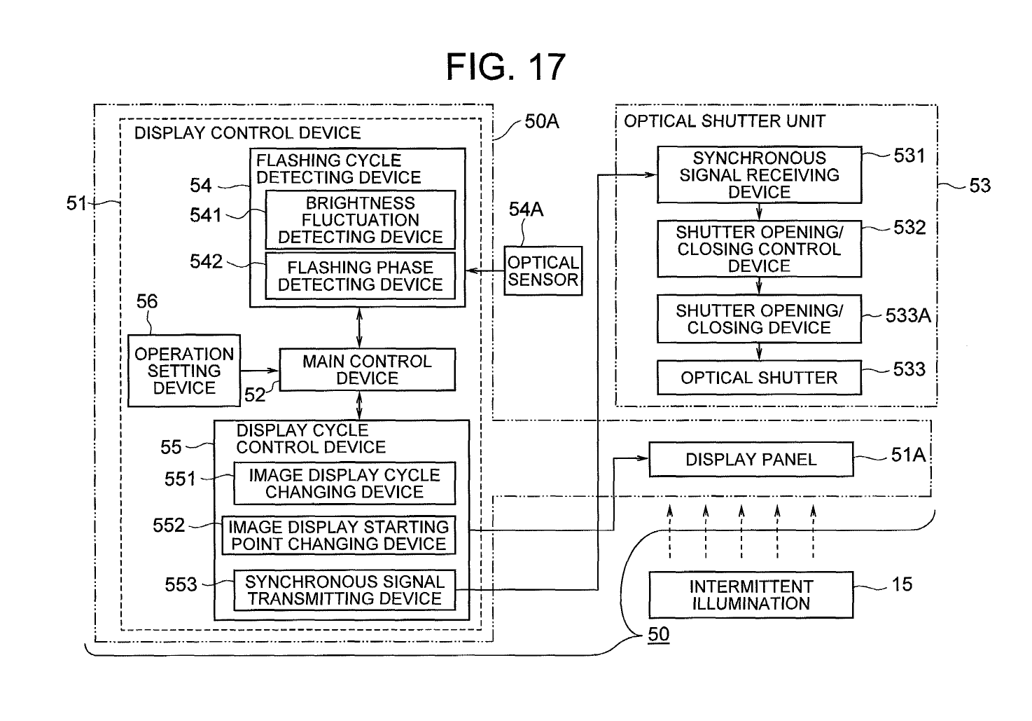

FIG. 18 is an explanatory diagram showing a schematic structure of the exemplary embodiment shown in FIG. 17;

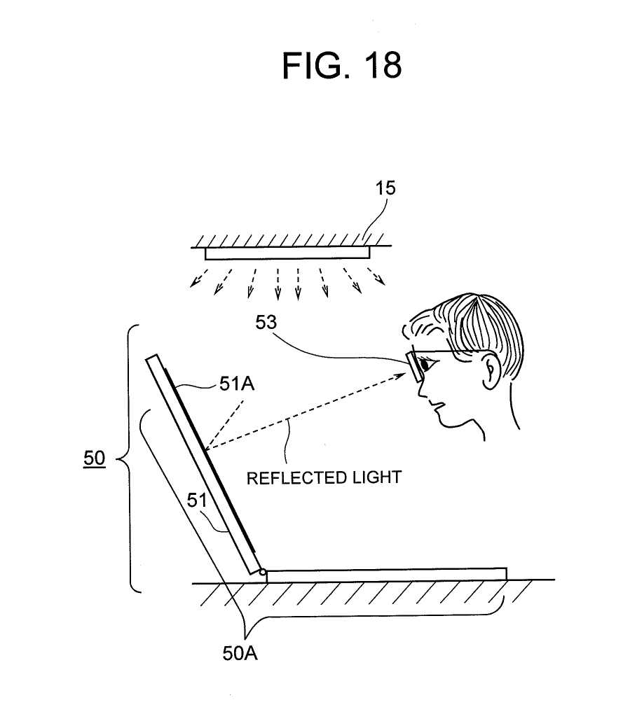

FIG. 19 is an explanatory diagram showing another schematic structure of the third exemplary embodiment of the invention.

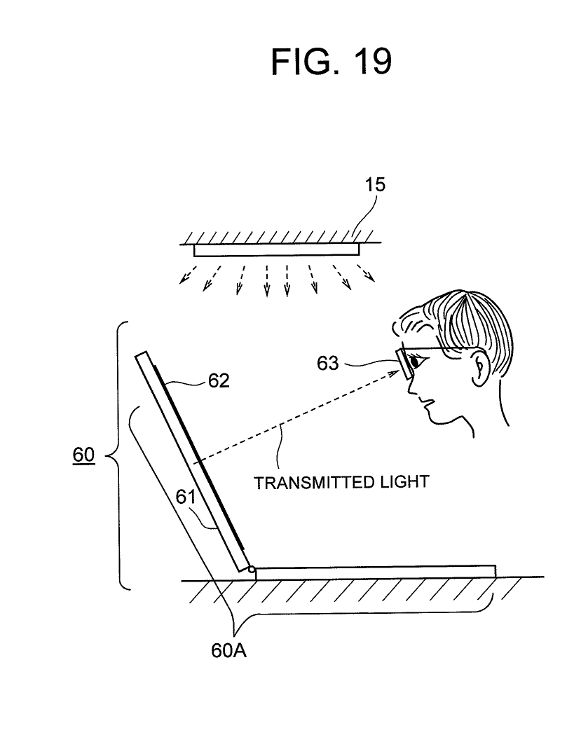

FIG. 20 is a flowchart showing a processing operation of the exemplary embodiment shown in FIG. 17;

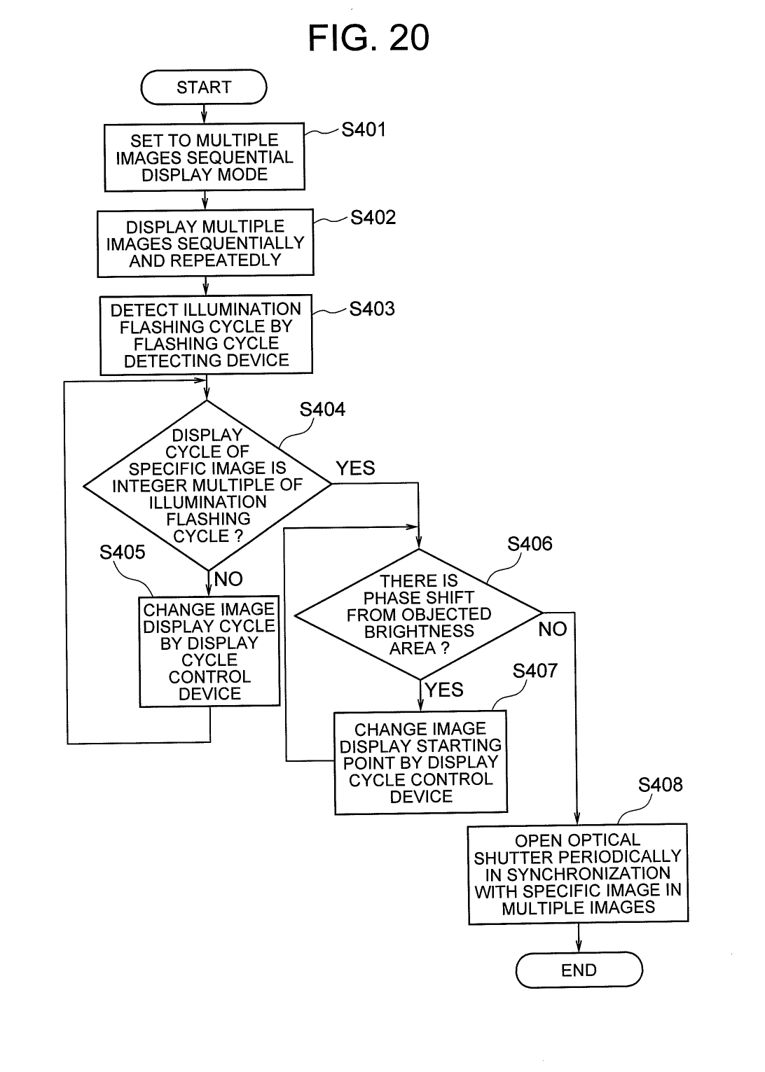

FIG. 21 is a timing chart showing a waveform of each part and timing thereof according to the exemplary embodiment shown in FIG. 17;

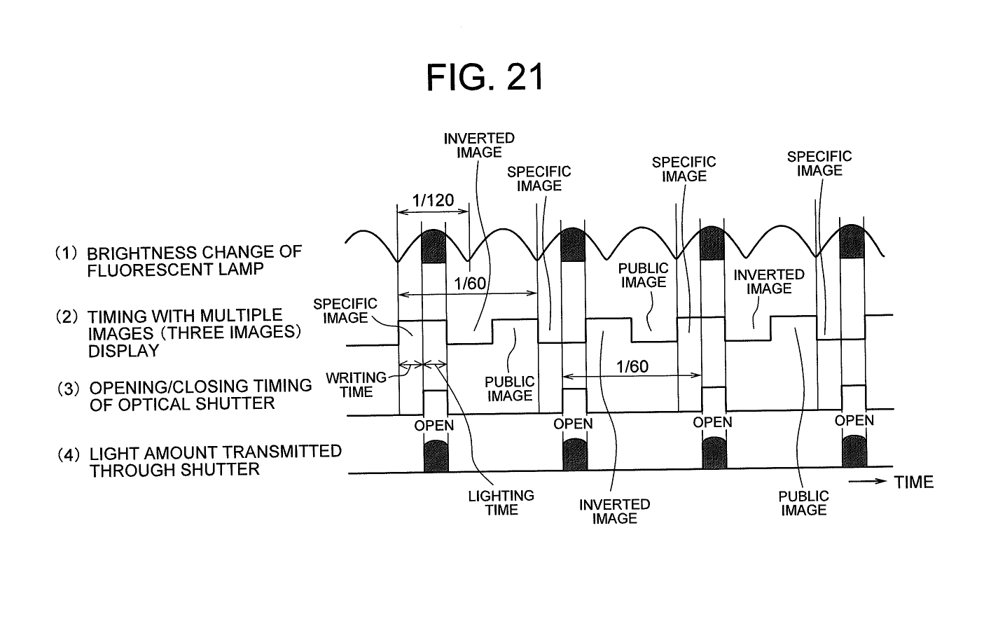

FIG. 22 is a timing chart showing a waveform of each part and timing thereof according to another example of the exemplary embodiment shown in FIG. 17;

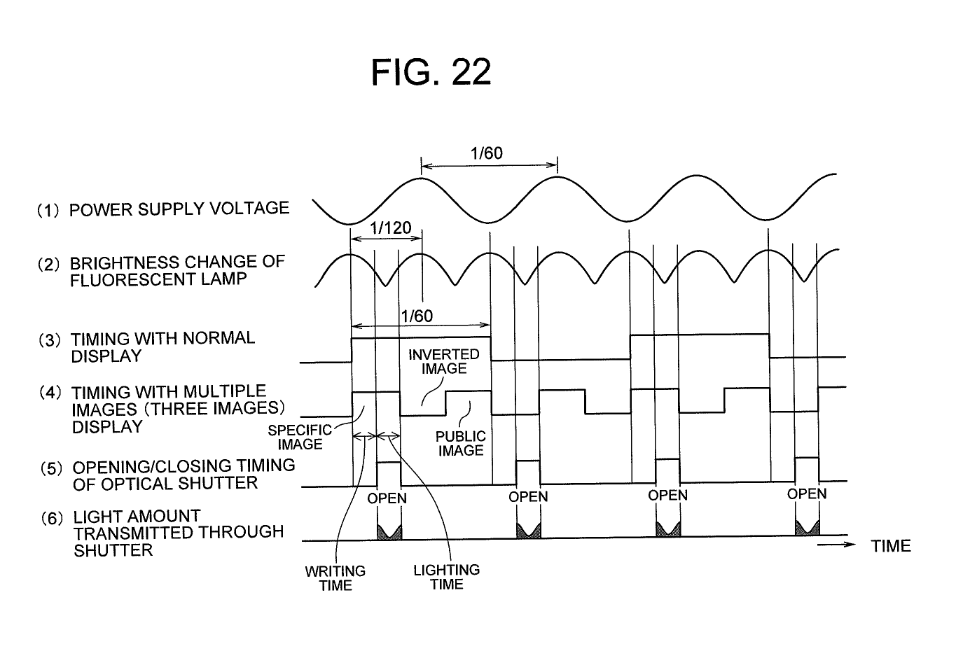

FIG. 23 is an explanatory diagram showing a structure of a fourth exemplary embodiment of the invention;

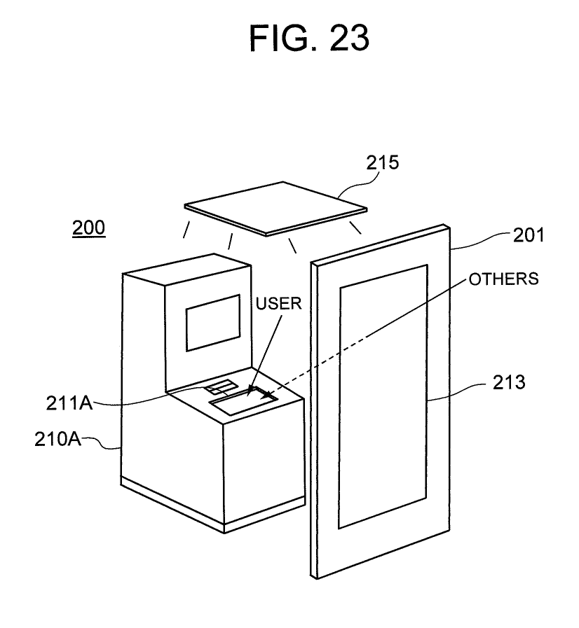

FIG. 24 is an explanatory diagram showing a structure of a fifth exemplary embodiment of the invention; and

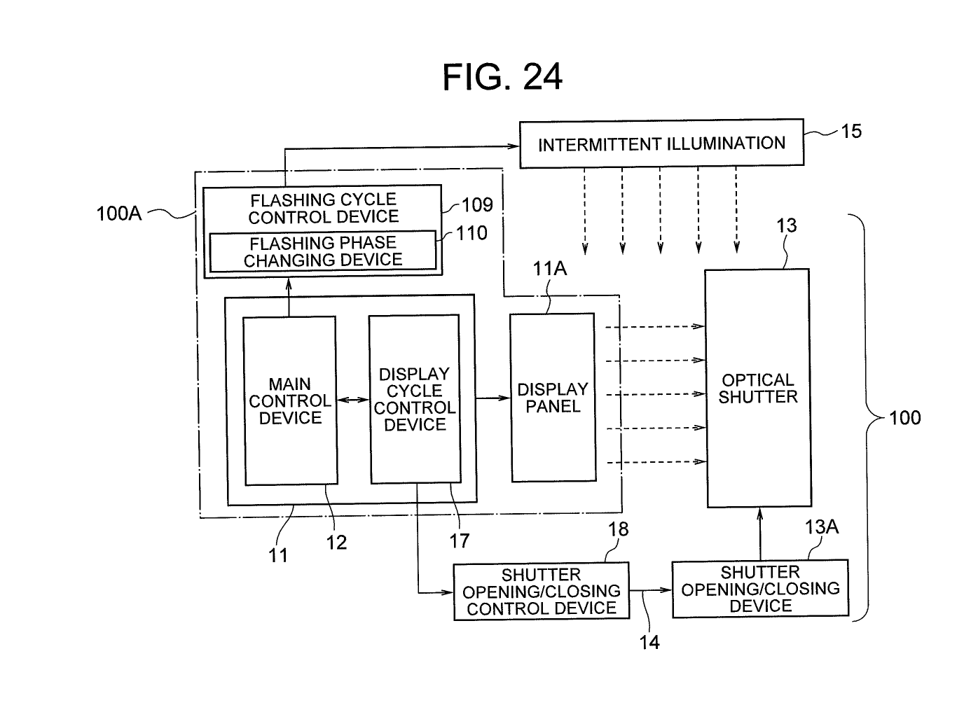

FIG. 25 is an explanatory diagram showing a related plural images display type display system.

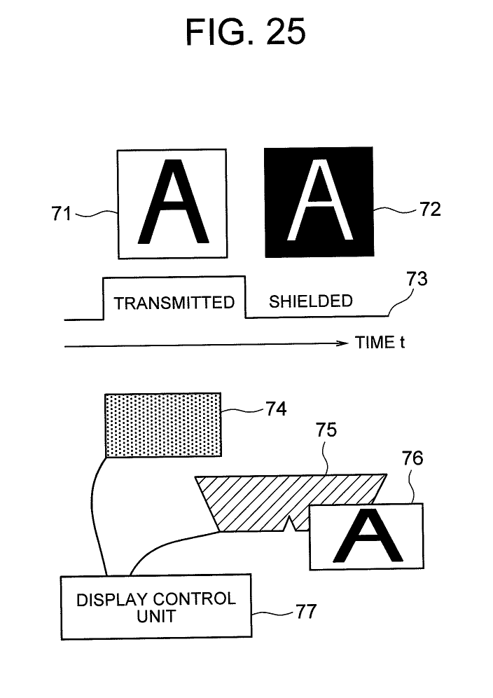

### REFERENCE NUMERALS

10, 20, 30, 40, 50, 60, 100, 200 Display system
10A, 20A, 30A, 40A, 50A, 60A, 210A Control device
11, 51, 61 Display control device
11A, 51A, 211A Display panel
13, 53, 63, 213 Optical shutter
14 Synchronous signal
15, 215 Intermittent illumination
23, 33, 44, 53 Optical shutter unit (Optical shutter)
18, 232, 38, 442, 532 Shutter opening/closing control device
17, 25, 34, 45, 47, 55 Display cycle control device
24, 36, 46, 54 Flashing cycle detecting device
109 Flashing cycle control device
110 Flashing phase changing device
542 Flashing phase detecting device

1. A display system which displays two or more types of images including a specific image sequentially and repeatedly by a display device under an intermittent illumination, comprising:
a control device which controls a display cycle of the specific image and a flashing cycle of the intermittent illumination in such a manner that the display cycle of the specific image is set equal to an integer multiple of the flashing cycle of the intermittent illumination under the intermittent illumination which flashes periodically.

2. The display system as claimed in claim 1, comprising an optical shutter, wherein
the optical shutter opens/closes in synchronization with the display cycle of the specific image to extract only the specific image.

3. The display system as claimed in claim 1, wherein
the control device comprises a flashing cycle detecting device which detects the flashing cycle of the intermittent illumination; and
a display cycle control device which changes the display cycle of the specific image,
the display cycle control device changing the display cycle of the specific image in such a manner that the display cycle of the specific image displayed by the display device is set equal to an integer multiple of the flashing cycle of the intermittent illumination under the intermittent illumination which flashes periodically, based on the flashing cycle detected by the flashing cycle detecting device.

4. The display system as claimed in claim 3, wherein
the control device further comprises a flashing cycle control device which changes the flashing cycle of the intermittent illumination
the flashing cycle control device controlling the flashing cycle of the intermittent illumination in such a manner that the display cycle of the specific image is set equal to an integer multiple of the flashing cycle of the intermittent illumination under the intermittent illumination which flashes periodically, based on the display cycle of the specific image.

5. The display system as claimed in claim 3, wherein
the flashing cycle detecting device comprises a flashing phase detecting device which detects the flashing phase of the intermittent illumination,
the display cycle control device comprises an image display starting point changing device which changes a display starting point of an image to be displayed,
the image display starting point changing device synchronizing the display starting point with the flashing phase detected by the flashing phase detecting device.

6. The display system as claimed in claim 4, wherein
the flashing cycle control device comprises a flashing phase changing device which changes the flashing phase of the intermittent illumination,
the flashing phase changing device synchronizing the flashing phase with the display starting point of the image to be displayed.

7. The display system as claimed in claim 3, wherein
the flashing cycle detecting device detects the flashing cycle or the flashing phase of the intermittent illumination from a waveform of an AC voltage of commercial power source applied to the display device.

8. The display system as claimed in claim 3, wherein
the display cycle control device sets the display cycle of the specific image to be either one of 1/50 second or 1/100 second when the flashing cycle detected by the flashing cycle detecting device is 1/100 second, and sets the display cycle of the specific image to be either one of 1/60 second or 1/120 second when the flashing cycle detected by the flashing cycle detecting device is 1/120 second.

9. The display system as claimed in claim 3, wherein:
the flashing cycle detecting device detects the flashing cycle or the flashing phase of the intermittent illumination by detecting a fluctuation in a brightness of the intermittent illumination.

10. The display system as claimed in claim 3, wherein
the flashing cycle detecting device comprises a transmitted light detecting device which detects a fluctuation in light transmitted through the optical shutter, and detects a fluctuation in a brightness of the intermittent illumination.

11. The display system as claimed in claim 5, comprising a display panel of reflection type or a transflective type, wherein
the image display starting point changing device changes the display starting point such that a value of integral of a transmitted light amount during an opening period of the optical shutter becomes a maximum based on a detection result of the flashing cycle detecting device.

12. The display system as claimed in claim 5, comprising a display panel of a transmission type, a transflective type, a projection type, or a light emitting type, wherein
the image display starting point changing device changes the display starting point such that a value of integral of the a transmitted light amount during an opening period of the optical shutter becomes a minimum based on a detection result of the flashing cycle detecting device.

13. The display system as claimed in claim 6, comprising a display panel of reflection type or a transflective type, wherein
the flashing phase changing device changes the flashing phase such that a value of integral of the a transmitted light amount during an opening period of the optical shutter becomes a maximum.

14. The display system as claimed in claim 6, comprising a display panel of a transmission type, a transflective type, a projection type, or a light emitting type, wherein
the flashing phase changing device changes the flashing phase such that a value of integral of the a transmitted light amount during an opening period of the optical shutter becomes a minimum.

15. The display system as claimed in claim 11, wherein
the flashing cycle detecting device comprises a transmitted light detecting device which detects a fluctuation in light transmitted through the optical shutter, and detects the brightness of the intermittent illumination.

16. The display system as claimed in claim 3, wherein the flashing cycle detecting device is built in the optical shutter.

17. The display system as claimed in claim 3, wherein the display cycle control device limits the display cycle of the specific image to 1/50 second or less.

18. The display system as claimed in claim 2, wherein the optical shutter is a liquid crystal shutter.

19. The display system as claimed in claim 1, wherein the two or more types of images includes the specific image and an inverted image that is formed by inverting the specific image.

20. The display system as claimed in claim 1, wherein the specific image is a black image displayed on an entire screen.

21. The display system as claimed in claim 1, wherein a right eye image and a left eye image required for a stereoscopic vision are included in the images displayed sequentially and repeatedly.

22. A control system which controls sequential and repeated displays of two or more types of images including a specific image by a display device under an intermittent illumination, comprising:
a control device which controls a display cycle of the specific image and a flashing cycle of the intermittent illumination in such a manner that the display cycle of the specific image is set equal to an integer multiple of the flashing cycle of the intermittent illumination under the intermittent illumination which flashes periodically.

23. The control system as claimed in claim 22, wherein
the control device comprises a flashing cycle detecting device which detects the flashing cycle of the intermittent illumination; and
a display cycle control device which changes the display cycle of the specific image,
the display cycle control device changing the display cycle of the specific image in such a manner that the display cycle of the specific image displayed by the display device is set equal to an integer multiple of the flashing cycle of the intermittent illumination under the intermittent illumination which flashes periodically, based on the flashing cycle detected by the flashing cycle detecting device.

24. The control system as claimed in claim 22, wherein
the control device further comprises a flashing cycle control device which changes the flashing cycle of the intermittent illumination,
the flashing cycle control device controlling the flashing cycle of the intermittent illumination in such a manner that the display cycle of the specific image is set equal to an integer multiple of the flashing cycle of the intermittent illumination under the intermittent illumination which flashes periodically, based on the display cycle of the specific image.

25. The control system as claimed in claim 23, wherein
the flashing cycle detecting device comprises a flashing phase detecting device which detects the flashing phase of the intermittent illumination,
the display cycle control device comprises an image display starting point changing device which changes a display starting point of an image to be displayed,
the image display starting point changing device synchronizing the display starting point with the flashing phase detected by the flashing phase detecting device.

26. The control system as claimed in claim 25, wherein
the flashing cycle control device comprises a flashing phase changing device which changes the flashing phase of the intermittent illumination,
the flashing phase changing device synchronizing the flashing phase with the display starting point of the image to be displayed.

27. The control system as claimed in claim 24, wherein
the flashing cycle detecting device detects the flashing cycle or the flashing phase of the intermittent illumination from a waveform of AC voltage of commercial power source applied to the display device.

28. The control system as claimed in claim 24, wherein
the display cycle control device sets the display cycle of the specific image to be either one of 1/50 second or 1/100 second when the flashing cycle detected by the flashing cycle detecting device is 1/100 second, and sets the display cycle of the specific image to be either one of 1/60 second or 1/120 second when the flashing cycle detected by the flashing cycle detecting device is 1/120 second.

29. The control system as claimed in claim 24, wherein
the flashing cycle detecting device detects the flashing cycle or the flashing phase of the intermittent illumination by detecting a fluctuation in brightness of the intermittent illumination.

30. The control system as claimed in claim 24, wherein
the flashing cycle detecting device comprises a transmitted light detecting device which detects a fluctuation in light transmitted through the optical shutter, and detects a fluctuation in brightness of the intermittent illumination.

31. The control system as claimed in claim 26, comprising a display panel of reflection type or a transflective type, wherein
the image display starting point changing device changes the display starting point such that a value of integral of a transmitted light amount during an opening period of the optical shutter becomes a maximum based on a detection result of the flashing cycle detecting device.

32. The control system as claimed in claim 26, comprising a display panel of a transmission type, a transflective type, a projection type, or a light emitting type, wherein
the image display starting point changing device changes the display starting point such that a value of integral of a transmitted light amount during an opening period of the optical shutter becomes a minimum based on a detection result of the flashing cycle detecting device.

33. The control system as claimed in claim 27, comprising a display panel a reflection type or a transflective type, wherein
the flashing phase changing device changes the flashing phase such that a value of integral of a transmitted light amount during an opening period of the optical shutter becomes a maximum.

34. The control system as claimed in claim 27, comprising a display panel of a transmission type, a transflective type, a projection type, or a light emitting type, wherein
the flashing phase changing device changes the flashing phase such that a value of integral of a transmitted light amount during an opening period of the optical shutter becomes a minimum.

35. The control system as claimed in claim 32, wherein:
the flashing cycle detecting device comprises a transmitted light detecting device which detects a fluctuation in light transmitted through the optical shutter, and detects the brightness of the intermittent illumination.

36. The control system as claimed in claim 23, wherein
the display cycle control device limits the display cycle of the specific image to 1/50 second or less.

37. A specific image display method comprising: controlling a display cycle of a specific image included in two or more types of images displayed sequentially and repeatedly and a flashing cycle of an intermittent illumination in such a manner that the display cycle of the specific image is set equal to an integer multiple of the flashing cycle of the intermittent illumination under the intermittent illumination which flashes periodically.

38. The specific image display method as claimed in claim 37, comprising:
detecting the flashing cycle of the intermittent illumination; and
controlling the display cycle of the specific image and a flashing cycle of an intermittent illumination in such a manner that the display cycle of the specific image displayed by the display device is set equal to an integer multiple of the flashing cycle of the intermittent illumination, based on the detected flashing cycle.

39. The specific image display method as claimed in claim 38, comprising:
detecting a flashing phase of the intermittent illumination; and
changing the display starting point of the image to be displayed, based on the detected flashing phase.

40. A computer readable recording medium storing an operation control program for controlling an optical shutter to open/close in synchronization with a display of a specific image included in two or more types of images to be displayed, causing a computer to execute a function of:
controlling a display cycle of the specific image and a flashing cycle of the intermittent illumination in such a manner that the display cycle of the specific image is set equal to an integer multiple of the flashing cycle of the intermittent illumination under the intermittent illumination which flashes periodically.

41. A display system which displays two or more types of images including a specific image sequentially and repeatedly by a display device under an intermittent illumination, comprising:
control means for controlling a display cycle of the specific image and a flashing cycle of the intermittent illumination in such a manner that the display cycle of the specific image is set equal to an integer multiple of the flashing cycle of the intermittent illumination under the intermittent illumination which flashes periodically.

42. A control system which controls sequential and repeated displays of two or more types of images including a specific image by a display device under an intermittent illumination, comprising:
control means for controlling a display cycle of the specific image and a flashing cycle of the intermittent illumination in such a manner that the display cycle of the specific image is set equal to an integer multiple of the flashing cycle of the intermittent illumination under the intermittent illumination which flashes periodically.
